(19) United States
(12) Patent Application Publication
(10) Pub. No.: US 2026/0279252 A1
(43) Pub. Date: Sep. 17, 2026

(54) PIXEL CIRCUIT AND DISPLAY DEVICE

(71) Applicants: Beijing BOE Technology Development Co., Ltd., Beijing (CN); BOE TECHNOLOGY GROUP CO., LTD., Beijing (CN)

(72) Inventors: Li Xiao, Beijing (CN); Haoliang Zheng, Beijing (CN); Minghua Xuan, Beijing (CN)

(73) Assignees: Beijing BOE Technology Development Co., Ltd., Beijing (CN); BOE TECHNOLOGY GROUP CO., LTD., Beijing (CN)

(21) Appl. No.: 18/866,827

(22) PCT Filed: Oct. 26, 2023
(86) PCT No.: PCT/CN2023/126868

§ 371 Date: Nov. 18, 2024

(51) Int. Cl. G09G 3/32

(52) U.S. Cl. CPC G09G 3/32; G09G 2300/0819; G09G 2300/0842; G09G 2310/08; G09G 2320/0233; G09G 2320/045

(57) ABSTRACT

A pixel circuit and a display device are provided. The pixel circuit includes a light-emitting element, a drive circuit, a light-emitting control circuit, and a drive control circuit. The light-emitting control circuit controls connection between the drive circuit and the light-emitting element or between the drive circuit and a power supply voltage terminal under control of potential of a control node. The drive circuit generates a drive current flowing from the power supply voltage terminal to the light-emitting element under control of potential of a first node. The drive control circuit controls connection between the control node and a light-emitting control terminal or a light-emitting control voltage terminal according to voltage signal provided by a data line under control of an initial control signal. In operation, the pixel circuit may eliminate influence of IR voltage drop at the power supply voltage terminal on display uniformity.

### TECHNICAL FIELD

The present disclosure relates to the technical field of display, and in particular to a pixel circuit and a display device.

### BACKGROUND

The display market is currently experiencing robust growth. With continued increase in consumer demand for various types of display products, such as laptops, smart phones, televisions, tablet computers, smart watches and fitness wristbands, an even greater variety of new display products are expected to emerge in the future. Micro LED (micro light-emitting diode) display technology has advantages such as low power consumption, high brightness, ultra-high resolution and color saturation, fast response speed, extreme energy efficiency, long lifespan, and high efficiency, making it considered as the most competitive next-generation display technology.

In micro light-emitting diode display, since the drive current of the micro light-emitting diode is relatively large, the voltage drop of the power supply voltage in the display panel increases sharply as the multiple of the current increases, thereby affecting display uniformity of the back panel.

### SUMMARY

In an aspect, embodiments of the present disclosure provide a pixel circuit, including a light-emitting element, a drive circuit, a light-emitting control circuit, and a drive control circuit;
the light-emitting control circuit is electrically connected to a control node, and is configured to control connection between the drive circuit and the light-emitting element or between the drive circuit and a power supply voltage terminal under control of a potential of the control node.
the drive circuit is electrically connected to a first node, and the drive circuit is configured to generate a drive current flowing from the power supply voltage terminal to the light-emitting element under control of a potential of the first node; and
the drive control circuit is electrically connected to the control node, a data line, an initial control terminal, a light-emitting control terminal, and a light-emitting control voltage terminal, and is configured to control connection between the control node and the light-emitting control terminal or the light-emitting control voltage terminal according to a voltage signal provided by the data line under control of an initial control signal provided by the initial control terminal.

Optionally, a control terminal of the drive circuit is electrically connected to the first node, a first terminal of the drive circuit is electrically connected to the power supply voltage terminal, and a second terminal of the drive circuit is electrically connected to a drive node, and the drive circuit is configured to generate a drive current flowing from the power supply voltage terminal to the drive node under control of the potential of the first node;
the light-emitting control circuit is further electrically connected to the drive node and a first electrode of the light-emitting element, and is configured to control connection between the drive node and the first electrode of the light-emitting element under control of the potential of the control node; and a second electrode of the light-emitting element is electrically connected to a first voltage terminal.

Optionally, a control terminal of the drive circuit is electrically connected to the first node, a first terminal of the drive circuit is electrically connected to a drive node, a second terminal of the drive circuit is electrically connected to a first voltage terminal, and the drive circuit is configured to generate a drive current flowing from the drive node to the first voltage terminal under control of the potential of the first node;
a first electrode of the light-emitting element is electrically connected to the power supply voltage terminal; and
the light-emitting control circuit is further electrically connected to a second electrode of the light-emitting element and the drive node, and is configured to control connection between the second electrode of the light-emitting element and the drive node under control of the potential of the control node.

Optionally, the pixel circuit according to at least one embodiment of the present disclosure further includes an energy storage circuit and a voltage control circuit;
a first terminal of the energy storage circuit is electrically connected to the first node, a second terminal of the energy storage circuit is electrically connected to a second node, and the energy storage circuit is configured to store electric energy; and
the voltage control circuit is electrically connected to the light-emitting control terminal, a second voltage terminal, and the second node, and is configured to control connection between the second voltage terminal and the second node under control of a light-emitting control signal provided by the light-emitting control terminal.

Optionally, the initial control terminal includes a first initial control terminal and a second initial control terminal;

the drive control circuit includes a first write circuit, a second write circuit, a first control circuit, a second control circuit, a first voltage sustaining circuit, and a second voltage sustaining circuit;
the first write circuit is electrically connected to a third node, the data line, and the first initial control terminal, and is configured to control connection between the data line and the third node under control of a first initial control signal provided by the first initial control terminal;
the second write circuit is electrically connected to a fourth node, the data line, and the second initial control terminal, and is configured to control connection between the data line and the fourth node under control of a second initial control signal provided by the second initial control terminal;
the first control circuit is electrically connected to the third node, the light-emitting control terminal, and the control node, and is configured to control connection between the light-emitting control terminal and the control node under control of a potential of the third node;
the second control circuit is electrically connected to the fourth node, the light-emitting control voltage terminal, and the control node, and is configured to control connection between the light-emitting control voltage terminal and the control node under control of a potential of the fourth node;
the first voltage sustaining circuit is electrically connected to the third node, and is configured to sustain the potential of the third node; and the second voltage sustaining circuit is electrically connected to the fourth node, and is configured to sustain the potential of the fourth node.

Optionally, the pixel circuit according to at least one embodiment of the present disclosure further includes a first initialization circuit and a second initialization circuit;
the first initialization circuit is electrically connected to the first initial control terminal, an initial voltage terminal, and the first node, and is configured to write an initial voltage provided by the initial voltage terminal into the first node under control of the first initial control signal provided by the first initial control terminal; and
the second initialization circuit is electrically connected to the first initial control terminal, a reference voltage terminal, and the second node, and is configured to write a reference voltage provided by the reference voltage terminal into the second node under control of the first initial control signal provided by the first initial control terminal.

Optionally, the drive control circuit includes a third write circuit, a third control circuit, a fourth control circuit, and a third voltage sustaining circuit;
the third write circuit is electrically connected to a fifth node, the data line, and the initial control terminal, and is configured to control connection between the data line and the fifth node under control of the initial control signal provided by the initial control terminal;
the third control circuit is electrically connected to the fifth node, the light-emitting control terminal, and the control node, and is configured to control connection between the control node and the light-emitting control terminal under control of a potential of the fifth node;
the fourth control circuit is electrically connected to the fifth node, the light-emitting control voltage terminal, and the control node, and is configured to control connection between the control node and the light-emitting control voltage terminal under control of the potential of the fifth node; and
the third voltage sustaining circuit is electrically connected to the fifth node, and is configured to sustain the potential of the fifth node.

Optionally, the pixel circuit according to at least one embodiment of the present disclosure further includes a first initialization circuit and a second initialization circuit;
the first initialization circuit is electrically connected to the initial control terminal, an initial voltage terminal, and the first node, and is configured to write an initial voltage provided by the initial voltage terminal into the first node under control of the initial control signal provided by the initial control terminal; and
the second initialization circuit is electrically connected to the initial control terminal, a reference voltage terminal, and the second node, and is configured to write a reference voltage provided by the reference voltage terminal into the second node under control of the initial control signal provided by the initial control terminal.

Optionally, the pixel circuit of according to least one embodiment of the present disclosure further includes a data write circuit and a compensation control circuit;
the data write circuit is electrically connected to a write control terminal, the data line, and the second node, and is configured to control connection between the data line and the second node under control of a write control signal provided by the write control terminal; and
the compensation control circuit is electrically connected to a compensation control terminal, the first node, and a drive node, and is configured to control connection between the first node and the drive node under control of a compensation control signal provided by the compensation control terminal.

Optionally, the first write circuit includes a first transistor, the second write circuit includes a second transistor, the first control circuit includes a third transistor, and the second control circuit includes a fourth transistor;
a gate electrode of the first transistor is electrically connected to the first initial control terminal, a first electrode of the first transistor is electrically connected to the data line, and a second electrode of the first transistor is electrically connected to the third node;
a gate electrode of the second transistor is electrically connected to the second initial control terminal, a first electrode of the second transistor is electrically connected to the data line, and a second electrode of the second transistor is electrically connected to the fourth node;
a gate electrode of the third transistor is electrically connected to the third node, a first electrode of the third transistor is electrically connected to the light-emitting control terminal, and a second electrode of the third transistor is electrically connected to the control node; and
a gate electrode of the fourth transistor is electrically connected to the fourth node, a first electrode of the fourth transistor is electrically connected to the light-emitting control voltage terminal, and a second electrode of the fourth transistor is electrically connected to the control node.

Optionally, the first voltage sustaining circuit includes a first capacitor, and the second voltage sustaining circuit includes a second capacitor;
a first terminal of the first capacitor is electrically connected to the third node, and a second terminal of the first capacitor is electrically connected to a direct current voltage terminal; and
a first terminal of the second capacitor is electrically connected to the fourth node, and a second terminal of the second capacitor is electrically connected to the direct current voltage terminal.

Optionally, the first initialization circuit includes a fifth transistor, and the second initialization circuit includes a sixth transistor;
a gate electrode of the fifth transistor is electrically connected to the first initial control terminal, a first electrode of the fifth transistor is electrically connected to the initial voltage terminal, and a second electrode of the fifth transistor is electrically connected to the first node; and
a gate electrode of the sixth transistor is electrically connected to the first initial control terminal, a first electrode of the sixth transistor is electrically connected to the reference voltage terminal, and a second electrode of the sixth transistor is electrically connected to the second node.

Optionally, the third write circuit includes a seventh transistor, the third control circuit includes an eighth transistor, and the fourth control circuit includes a ninth transistor;
a gate electrode of the seventh transistor is electrically connected to the initial control terminal, a first electrode of the seventh transistor is electrically connected to the data line, and a second electrode of the seventh transistor is electrically connected to the fifth node;
a gate electrode of the eighth transistor is electrically connected to the fifth node, a first electrode of the eighth transistor is electrically connected to the light-emitting control terminal, and a second electrode of the eighth transistor is electrically connected to the control node; and
a gate electrode of the ninth transistor is electrically connected to the fifth node, a first electrode of the ninth transistor is electrically connected to the light-emitting control voltage terminal, and a second electrode of the ninth transistor is electrically connected to the control node.

Optionally, the third voltage sustaining circuit includes a third capacitor; and
a first terminal of the third capacitor is electrically connected to the fifth node, and a second terminal of the third capacitor is electrically connected to a direct current voltage terminal.

Optionally, the first initialization circuit includes a fifth transistor, and the second initialization circuit includes a sixth transistor;
a gate electrode of the fifth transistor is electrically connected to the initial control terminal, a first electrode of the fifth transistor is electrically connected to the initial voltage terminal, and a second electrode of the fifth transistor is electrically connected to the first node; and
a gate electrode of the sixth transistor is electrically connected to the initial control terminal, a first electrode of the sixth transistor is electrically connected to the reference voltage terminal, and the second electrode of the fifth transistor is electrically connected to the second node.

Optionally, the drive circuit includes a drive transistor, and the light-emitting control circuit includes a tenth transistor;
a gate electrode of the drive transistor is electrically connected to the first node, a first electrode of the drive transistor is electrically connected to the power supply voltage terminal, and a second electrode of the drive transistor is electrically connected to the drive node; and
a gate electrode of the tenth transistor is electrically connected to the light-emitting control terminal, a first electrode of the tenth transistor is electrically connected to the power supply voltage terminal, and a second electrode of the tenth transistor is electrically connected to the first electrode of the light-emitting element.

Optionally, the drive circuit includes a drive transistor, and the light-emitting control circuit includes a tenth transistor;
a gate electrode of the drive transistor is electrically connected to the first node, a first electrode of the drive transistor is electrically connected to the drive node, and a second electrode of the drive transistor is electrically connected to the first voltage terminal; and
a gate electrode of the tenth transistor is electrically connected to the light-emitting control terminal, a first electrode of the tenth transistor is electrically connected to the second electrode of the light-emitting element, and a second electrode of the tenth transistor is electrically connected to the drive node.

Optionally, the energy storage circuit includes a storage capacitor, and the voltage control circuit includes an eleventh transistor;
a first terminal of the storage capacitor is electrically connected to the first node, and a second terminal of the storage capacitor is electrically connected to the second node; and
a gate electrode of the eleventh transistor is electrically connected to the light-emitting control terminal, a first electrode of the eleventh transistor is electrically connected to the second voltage terminal, and a second electrode of the eleventh transistor is electrically connected to the second node.

Optionally, the data write circuit includes a twelfth transistor, and the compensation control circuit includes a thirteenth transistor;
a gate electrode of the twelfth transistor is electrically connected to the write control terminal, a first electrode of the twelfth transistor is electrically connected to the data line, and a second electrode of the twelfth transistor is electrically connected to the second node; and
a gate electrode of the thirteenth transistor is electrically connected to the compensation control terminal, a first electrode of the thirteenth transistor is electrically connected to the first node, and a second electrode of the thirteenth transistor is electrically connected to the drive node.

In a second aspect, embodiments of the present disclosure provide a display device, including the pixel circuit as described above.

### BRIEF DESCRIPTION OF THE DRAWINGS

FIG. 1 is a structural diagram of a pixel circuit according to embodiments of the present disclosure;

FIG. 2 is a structural diagram of a pixel circuit according to at least one embodiment of the present disclosure;

FIG. 3 is a structural diagram of a pixel circuit according to at least one embodiment of the present disclosure;

FIG. 4 is a structural diagram of a pixel circuit according to at least one embodiment of the present disclosure;

FIG. 5 is a structural diagram of a pixel circuit according to at least one embodiment of the present disclosure;

FIG. 6 is a structural diagram of a pixel circuit according to at least one embodiment of the present disclosure;

FIG. 7 is a structural diagram of a pixel circuit according to at least one embodiment of the present disclosure;

FIG. 8 is a structural diagram of a pixel circuit according to at least one embodiment of the present disclosure;

FIG. 9 is a structural diagram of a pixel circuit according to at least one embodiment of the present disclosure;

FIG. 10 is a structural diagram of a pixel circuit according to at least one embodiment of the present disclosure;

FIG. 11 is a structural diagram of a pixel circuit according to at least one embodiment of the present disclosure;

FIG. 12 is a structural diagram of a pixel circuit according to at least one embodiment of the present disclosure;

FIG. 13 is a structural diagram of a pixel circuit according to at least one embodiment of the present disclosure;

FIG. 14 is a structural diagram of a pixel circuit according to at least one embodiment of the present disclosure;

FIG. 15 is a structural diagram of a pixel circuit according to at least one embodiment of the present disclosure;

FIG. 16 is a structural diagram of a pixel circuit according to at least one embodiment of the present disclosure;

FIG. 17 is a circuit diagram of a pixel circuit according to at least one embodiment of the present disclosure;

FIG. 18 is a timing diagram of operation of at least one embodiment of the pixel circuit shown in FIG. 17;

FIG. 19 is a circuit diagram of a pixel circuit according to at least one embodiment of the present disclosure;

FIG. 20 is a timing diagram of operation of at least one embodiment of the pixel circuit shown in FIG. 19;

FIG. 21 is a circuit diagram of a pixel circuit according to at least one embodiment of the present disclosure;

FIG. 22 is a timing diagram of operation of at least one embodiment of the pixel circuit shown in FIG. 21 of the present disclosure;

FIG. 23 is a circuit diagram of a pixel circuit according to at least one embodiment of the present disclosure;

FIG. 24 is a timing diagram of operation of at least one embodiment of the pixel circuit shown in FIG. 23 of the present disclosure;

FIG. 25 is a circuit diagram of a pixel circuit according to at least one embodiment of the present disclosure;

FIG. 26 is a circuit diagram of a pixel circuit according to at least one embodiment of the present disclosure; and

FIG. 27 is a circuit diagram of a pixel circuit according to at least one embodiment of the present disclosure.

### DETAILED DESCRIPTION

The technical solutions in embodiments of the present disclosure are described clearly and completely in conjunction with drawings in the embodiments of the present disclosure. Apparently, the described embodiments are merely a part of rather than all the embodiments of the present disclosure. All other embodiments obtained by a person ordinary skilled in the art based on the embodiments of the present disclosure without any creative efforts fall within the protection scope of the present disclosure.

The transistors used in all embodiments of the present disclosure may be thin film transistors or field effect transistors or other devices having the same characteristics. In embodiments of the present disclosure, to distinguish between two electrodes of a transistor other than a gate electrode, one of the electrodes is referred to as a first electrode and the other is referred to as a second electrode.

In practical operation, when the transistor is a thin film transistor or a field effect transistor, the first electrode may be a drain electrode, and the second electrode may be a source electrode. Or, the first electrode may be a source electrode, and the second electrode may be a drain electrode.

A pixel circuit according to embodiments of the present disclosure includes a light-emitting element, a drive circuit, a light-emitting control circuit, and a drive control circuit;
the light-emitting control circuit is electrically connected to a control node, and is configured to control connection between the drive circuit and the light-emitting element or between the drive circuit and a power supply voltage terminal under control of a potential of the control node;
the drive circuit is electrically connected to a first node, and the drive circuit is configured to generate a drive current flowing from the power supply voltage terminal to the light-emitting element under control of a potential of the first node; and
the drive control circuit is electrically connected to the control node, a data line, an initial control terminal, a light-emitting control terminal, and a light-emitting control voltage terminal, and is configured to control connection between the control node and the light-emitting control terminal or the light-emitting control voltage terminal according to a voltage signal provided by the data line under control of an initial control signal provided by the initial control terminal.

In operation, the pixel circuit according to the embodiments of the present disclosure may eliminate the influence of the IR Drop (IR voltage drop) at the power supply voltage terminal VDD on display uniformity.

In at least one embodiment of the present disclosure, a control terminal of the drive circuit is electrically connected to the first node, a first terminal of the drive circuit is electrically connected to the power supply voltage terminal, and a second terminal of the drive circuit is electrically connected to a drive node, and the drive circuit is configured to generate a drive current flowing from the power supply voltage terminal to the drive node under control of the potential of the first node;
the light-emitting control circuit is further electrically connected to the drive node and a first electrode of the light-emitting element, and is configured to control connection between the drive node and the first electrode of the light-emitting element under control of the potential of the control node; and a second electrode of the light-emitting element is electrically connected to a first voltage terminal.

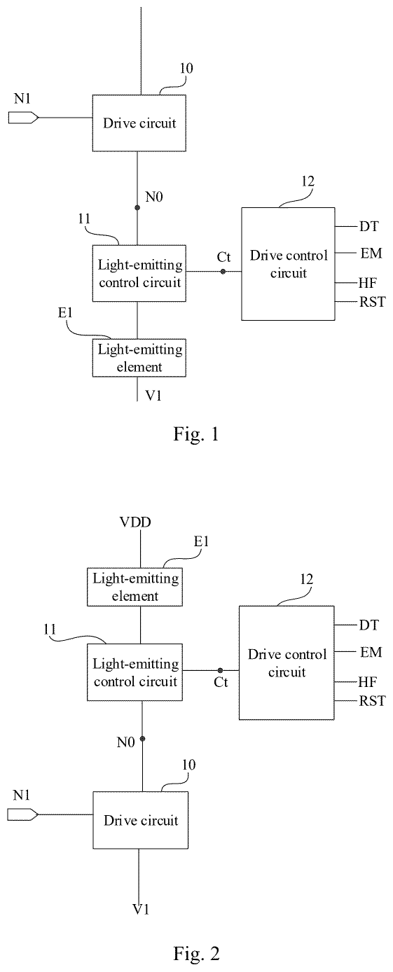

As shown in FIG. 1, a pixel circuit according to embodiments of the present disclosure includes a light-emitting element E1, a drive circuit 10, a light-emitting control circuit 11, and a drive control circuit 12.

A control terminal of the drive circuit 10 is electrically connected to the first node N1, a first terminal of the drive circuit 10 is electrically connected to the power supply voltage terminal VDD, and a second terminal of the drive circuit 10 is electrically connected to a drive node N0, and the drive circuit 10 is configured to generate a drive current flowing from the power supply voltage terminal VDD to the drive node N0 under control of the potential of the first node N1.

The light-emitting control circuit 11 is electrically connected to the control node Ct, the drive node N0, and a first electrode of the light-emitting element E1, and is configured to control connection between the drive node N0 and the first electrode of the light-emitting element E1 under control of the potential of the control node Ct; a second electrode of the light-emitting element E1 is electrically connected to a first voltage terminal V1.

The drive control circuit 12 is electrically connected to the control node Ct, a data line DT, an initial control terminal RST, a light-emitting control terminal EM, and a light-emitting control voltage terminal HF, and is configured to control connection between the control node Ct and the light-emitting control terminal EM or the light-emitting control voltage terminal HF according to a voltage signal provided by the data line DT under control of an initial control signal provided by the initial control terminal RST.

In at least one embodiment of the present disclosure, a control terminal of the drive circuit is electrically connected to the first node, a first terminal of the drive circuit is electrically connected to a drive node, a second terminal of the drive circuit is electrically connected to a first voltage terminal, and the drive circuit is configured to generate a drive current flowing from the drive node to the first voltage terminal under control of the potential of the first node;
a first electrode of the light-emitting element is electrically connected to the power supply voltage terminal; and
the light-emitting control circuit is further electrically connected to a second electrode of the light-emitting element and the drive node, and is configured to control connection between the second electrode of the light-emitting element and the drive node under control of the potential of the control node.

Optionally, the first voltage terminal may be a low voltage terminal.

As shown in FIG. 2, a pixel circuit according to embodiments of the present disclosure includes a light-emitting element E1, a drive circuit 10, a light-emitting control circuit 11, and a drive control circuit 12.

A control terminal of the drive circuit 10 is electrically connected to the first node N1, a first terminal of the drive circuit 10 is electrically connected to a drive node N0, a second terminal of the drive circuit 10 is electrically connected to a first voltage terminal V1, and the drive circuit 10 is configured to generate a drive current flowing from the drive node N0 to the first voltage terminal V1 under control of the potential of the first node N1.

A first electrode of the light-emitting element E1 is electrically connected to the power supply voltage terminal VDD.

The light-emitting control circuit 11 is electrically connected to the control node Ct, a second electrode of the light-emitting element E1, and the drive node NO, and is configured to control connection between the second electrode of the light-emitting element E1 and the drive node NO under control of the potential of the control node Ct.

The drive control circuit 12 is electrically connected to the control node Ct, a data line DT, an initial control terminal RST, a light-emitting control terminal EM, and a light-emitting control voltage terminal HF, and is configured to control connection between the control node Ct and the light-emitting control terminal EM or the light-emitting control voltage terminal HF according to a voltage signal provided by the data line DT under control of an initial control signal provided by the initial control terminal RST.

The pixel circuit according to at least one embodiment of the present disclosure may further include an energy storage circuit and a voltage control circuit;
a first terminal of the energy storage circuit is electrically connected to the first node, a second terminal of the energy storage circuit is electrically connected to a second node, and the energy storage circuit is configured to store electric energy; and
the voltage control circuit is electrically connected to the light-emitting control terminal, a second voltage terminal, and the second node, and is configured to control connection between the second voltage terminal and the second node under control of a light-emitting control signal provided by the light-emitting control terminal.

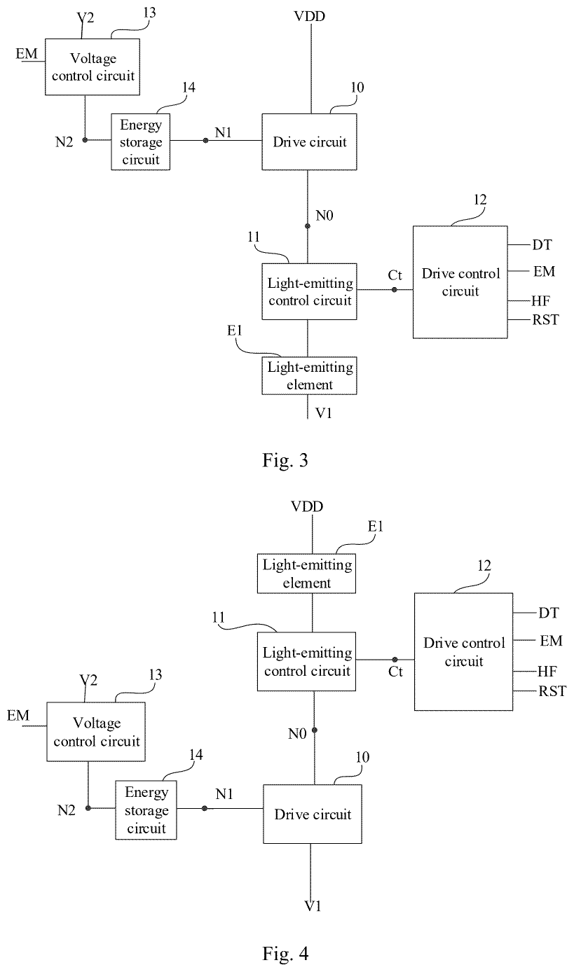

As shown in FIG. 3, on the basis of at least one embodiment of the pixel circuit shown in FIG. 1, the pixel circuit according to at least one embodiment of the present disclosure may further include a voltage control circuit 13 and an energy storage circuit 14.

A first terminal of the energy storage circuit 14 is electrically connected to the first node N1, a second terminal of the energy storage circuit 14 is electrically connected to a second node N2, and the energy storage circuit 14 is configured to store electric energy.

The voltage control circuit 13 is electrically connected to the light-emitting control terminal EM, a second voltage terminal V2, and the second node N2, and is configured to control connection between the second voltage terminal V2 and the second node N2 under control of a light-emitting control signal provided by the light-emitting control terminal EM.

As shown in FIG. 4, on the basis of at least one embodiment of the pixel circuit shown in FIG. 2, the pixel circuit according to at least one embodiment of the present disclosure may further include a voltage control circuit 13 and an energy storage circuit 14.

A first terminal of the energy storage circuit 14 is electrically connected to the first node N1, a second terminal of the energy storage circuit 14 is electrically connected to a second node N2, and the energy storage circuit 14 is configured to store electric energy.

The voltage control circuit 13 is electrically connected to the light-emitting control terminal EM, a second voltage terminal V2, and the second node N2, and is configured to control connection between the second voltage terminal V2 and the second node N2 under control of a light-emitting control signal provided by the light-emitting control terminal EM.

In at least one embodiment of the present disclosure, the initial control terminal includes a first initial control terminal and a second initial control terminal;
the drive control circuit includes a first write circuit, a second write circuit, a first control circuit, a second control circuit, a first voltage sustaining circuit, and a second voltage sustaining circuit;
the first write circuit is electrically connected to a third node, the data line, and the first initial control terminal, and is configured to control connection between the data line and the third node under control of a first initial control signal provided by the first initial control terminal;
the second write circuit is electrically connected to a fourth node, the data line, and the second initial control terminal, and is configured to control connection between the data line and the fourth node under control of a second initial control signal provided by the second initial control terminal;
the first control circuit is electrically connected to the third node, the light-emitting control terminal, and the control node, and is configured to control connection between the light-emitting control terminal and the control node under control of a potential of the third node;
the second control circuit is electrically connected to the fourth node, the light-emitting control voltage terminal, and the control node, and is configured to control connection between the light-emitting control voltage terminal and the control node under control of a potential of the fourth node;
the first voltage sustaining circuit is electrically connected to the third node, and is configured to sustain the potential of the third node; and
the second voltage sustaining circuit is electrically connected to the fourth node, and is configured to sustain the potential of the fourth node.

In a particular implementation, the initial control terminal may include a first initial control terminal and a second initial control terminal; the drive control circuit may include a first write circuit, a second write circuit, a first control circuit, a second control circuit, a first voltage sustaining circuit, and a second voltage sustaining circuit; the first write circuit controls connection between the data line and the third node under control of a first initial control signal; the second write circuit controls connection between the data line and the fourth node under control of a second initial control signal; the first control circuit controls connection between the light-emitting control terminal and the control node under control of a potential of the third node; the second control circuit controls connection between the light-emitting control voltage terminal and the control node under control of a potential of the fourth node; the first voltage sustaining circuit sustains the potential of the third node; and the second voltage sustaining circuit sustains the potential of the fourth node.

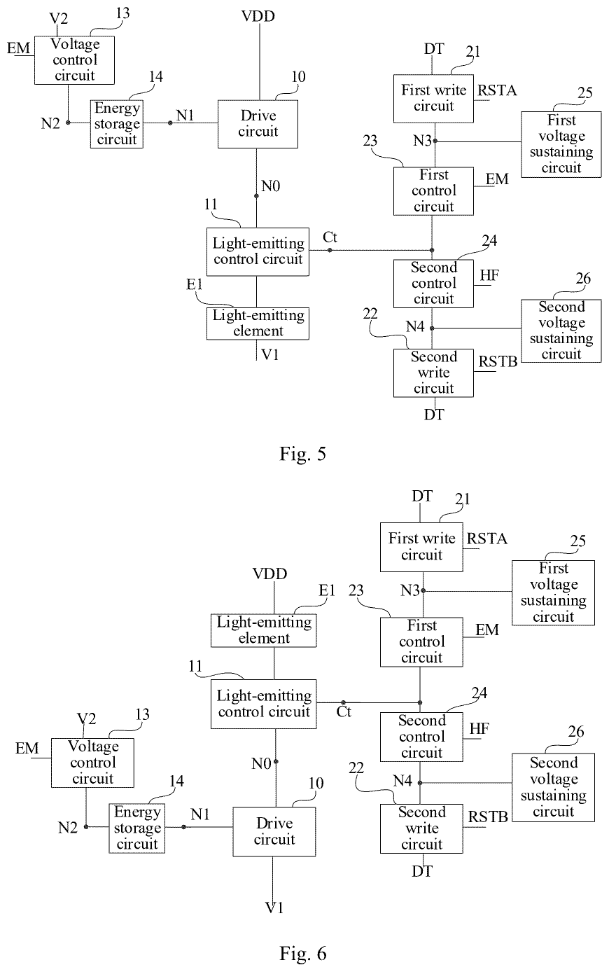

As shown in FIG. 5, on the basis of the embodiment of the pixel circuit shown in FIG. 3, the initial control terminal includes a first initial control terminal RSTA and a second initial control terminal RSTB.

The drive control circuit includes a first write circuit 21, a second write circuit 22, a first control circuit 23, a second control circuit 24, a first voltage sustaining circuit 25, and a second voltage sustaining circuit 26.

The first write circuit 21 is electrically connected to a third node N3, the data line DT, and the first initial control terminal RSTA, and is configured to control connection between the data line DT and the third node N3 under control of a first initial control signal provided by the first initial control terminal RSTA.

The second write circuit 22 is electrically connected to a fourth node N4, the data line DT, and the second initial control terminal RSTB, and is configured to control connection between the data line DT and the fourth node N4 under control of a second initial control signal provided by the second initial control terminal RSTB.

The first control circuit 23 is electrically connected to the third node N3, the light-emitting control terminal EM, and the control node Ct, and is configured to control connection between the light-emitting control terminal EM and the control node Ct under control of a potential of the third node N3.

The second control circuit 24 is electrically connected to the fourth node N4, the light-emitting control voltage terminal HF, and the control node Ct, and is configured to control connection between the light-emitting control voltage terminal HF and the control node Ct under control of the potential of the fourth node N4.

The first voltage sustaining circuit 25 is electrically connected to the third node N3, and is configured to sustain the potential of the third node N3.

The second voltage sustaining circuit 26 is electrically connected to the fourth node N4, and is configured to sustain the potential of the fourth node N4.

As shown in FIG. 6, on the basis of the embodiment of the pixel circuit shown in FIG. 4, the initial control terminal includes a first initial control terminal RSTA and a second initial control terminal RSTB.

The drive control circuit includes a first write circuit 21, a second write circuit 22, a first control circuit 23, a second control circuit 24, a first voltage sustaining circuit 25, and a second voltage sustaining circuit 26.

The first write circuit 21 is electrically connected to a third node N3, the data line DT, and the first initial control terminal RSTA, and is configured to control connection between the data line DT and the third node N3 under control of a first initial control signal provided by the first initial control terminal RSTA.

The second write circuit 22 is electrically connected to a fourth node N4, the data line DT, and the second initial control terminal RSTB, and is configured to control connection between the data line DT and the fourth node N4 under control of a second initial control signal provided by the second initial control terminal RSTB.

The first control circuit 23 is electrically connected to the third node N3, the light-emitting control terminal EM, and the control node Ct, and is configured to control connection between the light-emitting control terminal EM and the control node Ct under control of a potential of the third node N3.

The second control circuit 24 is electrically connected to the fourth node N4, the light-emitting control voltage terminal HF, and the control node Ct, and is configured to control connection between the light-emitting control voltage terminal HF and the control node Ct under control of the potential of the fourth node N4.

The first voltage sustaining circuit 25 is electrically connected to the third node N3, and is configured to sustain the potential of the third node N3.

The second voltage sustaining circuit 26 is electrically connected to the fourth node N4, and is configured to sustain the potential of the fourth node N4.

The pixel circuit according to at least one embodiment of the present disclosure further includes a first initialization circuit and a second initialization circuit;
the first initialization circuit is electrically connected to the first initial control terminal, an initial voltage terminal, and the first node, and is configured to write an initial voltage provided by the initial voltage terminal into the first node under control of the first initial control signal provided by the first initial control terminal; and
the second initialization circuit is electrically connected to the first initial control terminal, a reference voltage terminal, and the second node, and is configured to write a reference voltage provided by the reference voltage terminal into the second node under control of the first initial control signal provided by the first initial control terminal.

In a particular implementation, the pixel circuit may further include a first initialization circuit and a second initialization circuit, the first initialization circuit writes an initial voltage provided by the initial voltage terminal into the first node under control of a first initial control signal, and the second initialization circuit writes a reference voltage into the second node under control of the first initial control signal, so as to initialize the potential of the first node and the potential of the second node.

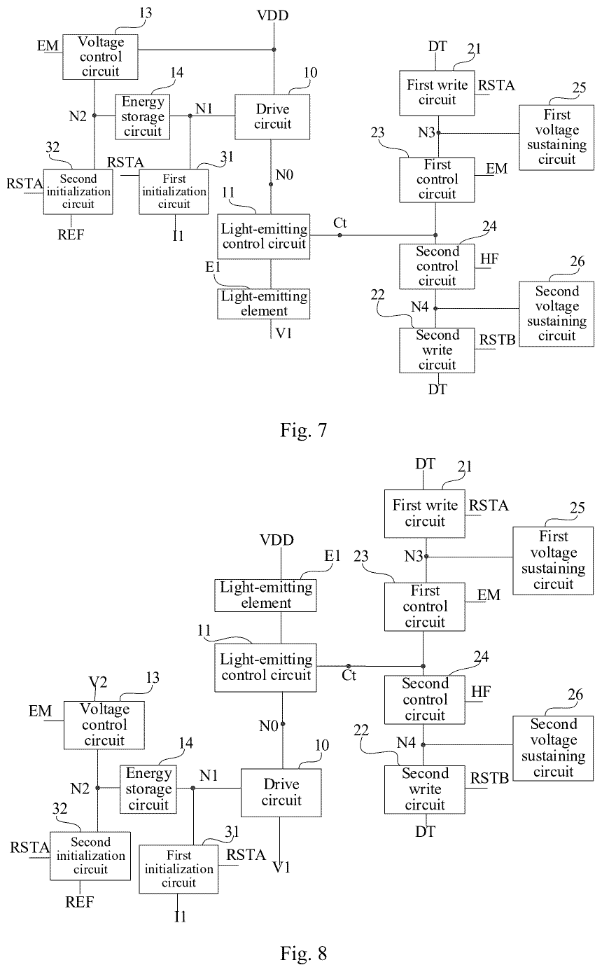

As shown in FIG. 7, on the basis of at least one embodiment of the pixel circuit shown in FIG. 5, the pixel circuit of at least one embodiment of the present disclosure further includes a first initialization circuit 31 and a second initialization circuit 32.

The first initialization circuit 31 is electrically connected to the first initial control terminal RSTA, an initial voltage terminal I1, and the first node N1, and is configured to write an initial voltage Vint provided by the initial voltage terminal I1 into the first node N1 under control of a first initial control signal provided by the first initial control terminal RSTA.

The second initialization circuit 32 is electrically connected to the first initial control terminal RSTA, the reference voltage terminal REF, and the second node N2, and is configured to write a reference voltage Vref provided by the reference voltage terminal REF into the second node N2 under control of the first initial control signal provided by the first initial control terminal RSTA.

As shown in FIG. 8, on the basis of at least one embodiment of the pixel circuit shown in FIG. 6, the pixel circuit of at least one embodiment of the present disclosure further includes a first initialization circuit 31 and a second initialization circuit 32.

The first initialization circuit 31 is electrically connected to the first initial control terminal RSTA, an initial voltage terminal I1, and the first node N1, and is configured to write an initial voltage Vint provided by the initial voltage terminal I1 into the first node N1 under control of a first initial control signal provided by the first initial control terminal RSTA.

The second initialization circuit 32 is electrically connected to the first initial control terminal RSTA, the reference voltage terminal REF, and the second node N2, and is configured to write a reference voltage Vref provided by the reference voltage terminal REF into the second node N2 under control of the first initial control signal provided by the first initial control terminal RSTA.

In at least one embodiment of the present disclosure, the drive control circuit may include a third write circuit, a third control circuit, a fourth control circuit, and a third voltage sustaining circuit; the third write circuit controls connection between the data line and the fifth node under control of an initial control signal;
the third control circuit is electrically connected to the fifth node, the light-emitting control terminal, and the control node, and is configured to control connection between the control node and the light-emitting control terminal under control of a potential of the fifth node;
the fourth control circuit is electrically connected to the fifth node, the light-emitting control voltage terminal, and the control node, and is configured to control connection between the control node and the light-emitting control voltage terminal under control of the potential of the fifth node; and
the third voltage sustaining circuit is electrically connected to the fifth node, and is configured to sustain the potential of the fifth node.

In a particular implementation, the drive control circuit may include a third write circuit, a third control circuit, a fourth control circuit, and a third voltage sustaining circuit; the third write circuit controls connection between the data line and the fifth node under control of an initial control signal; the third control circuit controls connection between the control node and the light-emitting control terminal under control of the potential of the fifth node; the fourth control circuit controls connection between the control node and the light-emitting control voltage terminal under control of the potential of the fifth node; and the third voltage sustaining circuit sustains the potential of the fifth node.

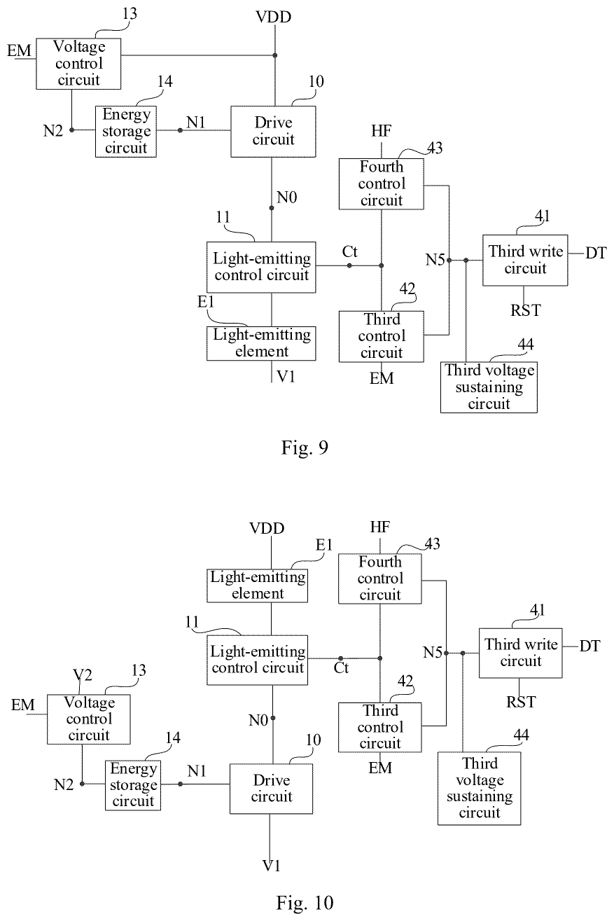

As shown in FIG. 9, on the basis of the embodiment of the pixel circuit shown in FIG. 3, the drive control circuit may include a third write circuit 41, a third control circuit 42, a fourth control circuit 43, and a third voltage sustaining circuit 44.

The third write circuit 41 is electrically connected to an initial control terminal RST, a data line DT, and a fifth node N5, and is configured to control connection between the data line DT and the fifth node N5 under control of an initial control signal provided by the initial control terminal RST.

The third control circuit 42 is electrically connected to the fifth node N5, the light-emitting control terminal EM, and the control node Ct, and is configured to control connection between the control node Ct and the light-emitting control terminal EM under control of a potential of the fifth node N5.

The fourth control circuit 43 is electrically connected to the fifth node N5, the light-emitting control voltage terminal HF, and the control node Ct, and is configured to control connection between the control node Ct and the light-emitting control voltage terminal HF under control of the potential of the fifth node N5; and

The third voltage sustaining circuit 44 is electrically connected to the fifth node N5, and is configured to sustain the potential of the fifth node N5.

As shown in FIG. 10, on the basis of the embodiment of the pixel circuit shown in FIG. 4, the drive control circuit may include a third write circuit 41, a third control circuit 42, a fourth control circuit 43, and a third voltage sustaining circuit 44.

The third write circuit 41 is electrically connected to an initial control terminal RST, a data line DT, and a fifth node N5, and is configured to control connection between the data line DT and the fifth node N5 under control of an initial control signal provided by the initial control terminal RST.

The third control circuit 42 is electrically connected to the fifth node N5, the light-emitting control terminal EM, and the control node Ct, and is configured to control connection between the control node Ct and the light-emitting control terminal EM under control of a potential of the fifth node N5.

The fourth control circuit 43 is electrically connected to the fifth node N5, the light-emitting control voltage terminal HF, and the control node Ct, and is configured to control connection between the control node Ct and the light-emitting control voltage terminal HF under control of the potential of the fifth node N5.

The third voltage sustaining circuit 44 is electrically connected to the fifth node N5, and is configured to sustain the potential of the fifth node N5.

The pixel circuit according to at least one embodiment of the present disclosure further includes a first initialization circuit and a second initialization circuit;
the first initialization circuit is electrically connected to the initial control terminal, an initial voltage terminal, and the first node, and is configured to write an initial voltage provided by the initial voltage terminal into the first node under control of the initial control signal provided by the initial control terminal; and the second initialization circuit is electrically connected to the first initial control terminal, a reference voltage terminal, and the second node, and is configured to write a reference voltage provided by the reference voltage terminal into the second node under control of the initial control signal provided by the initial control terminal.

In a particular implementation, the pixel circuit may further include a first initialization circuit and a second initialization circuit; the first initialization circuit writes an initial voltage into the first node under control of an initial control signal; and the second initialization circuit writes a reference voltage to the second node under control of an initial control signal.

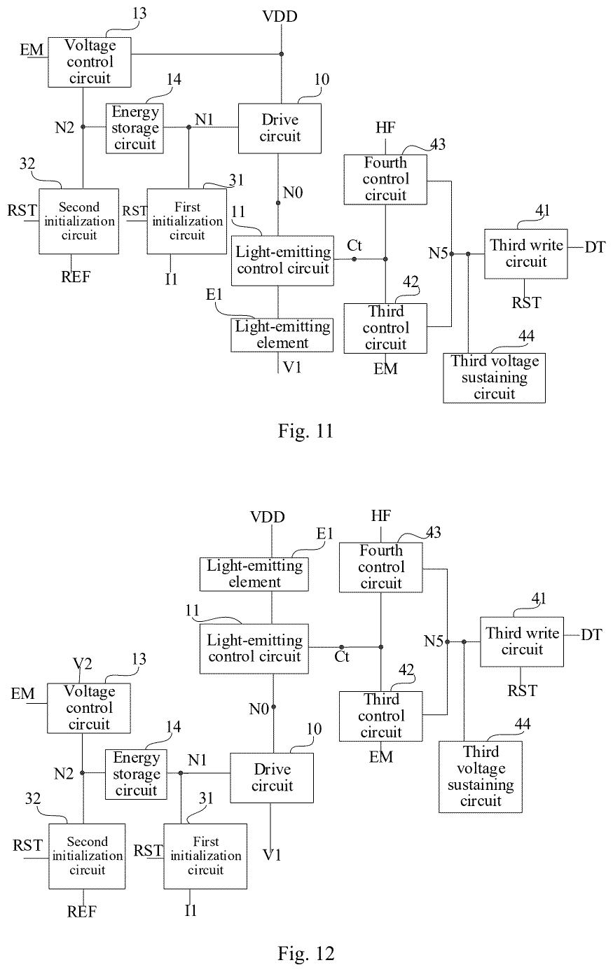

As shown in FIG. 11, on the basis of at least one embodiment of the pixel circuit shown in FIG. 9, the pixel circuit of at least one embodiment of the present disclosure further includes a first initialization circuit 31 and a second initialization circuit 32.

The first initialization circuit 31 is electrically connected to the initial control terminal RST, an initial voltage terminal I1, and the first node N1, and is configured to write an initial voltage Vint provided by the initial voltage terminal I1 into the first node N1 under control of an initial control signal provided by the initial control terminal RST.

The second initialization circuit 32 is electrically connected to the initial control terminal RST, the reference voltage terminal REF, and the second node N2, and is configured to write the reference voltage Vref provided by the reference voltage terminal REF into the second node N2 under control of the initial control signal provided by the initial control terminal RST.

As shown in FIG. 12, on the basis of at least one embodiment of the pixel circuit shown in FIG. 10, the pixel circuit of at least one embodiment of the present disclosure further includes a first initialization circuit 31 and a second initialization circuit 32.

The first initialization circuit 31 is electrically connected to the initial control terminal RST, an initial voltage terminal I1, and the first node N1, and is configured to write an initial voltage Vint provided by the initial voltage terminal I1 into the first node N1 under control of an initial control signal provided by the initial control terminal RST.

The second initialization circuit 32 is electrically connected to the initial control terminal RST, the reference voltage terminal REF, and the second node N2, and is configured to write the reference voltage Vref provided by the reference voltage terminal REF into the second node N2 under control of the initial control signal provided by the initial control terminal RST.

The pixel circuit according to at least one embodiment of the present disclosure further includes a data write circuit and a compensation control circuit;
the data write circuit is electrically connected to a write control terminal, the data line, and the second node, and is configured to control connection between the data line and the second node under control of a write control signal provided by the write control terminal; and
the compensation control circuit is electrically connected to a compensation control terminal, the first node, and the drive node, and is configured to control connection between the first node and the drive node under control of a compensation control signal provided by the compensation control terminal.

In a particular implementation, the pixel circuit may further include a data write circuit and a compensation control circuit, the data write circuit controls connection between the data line and the second node under control of a write control signal; and the compensation control circuit controls connection between the first node and the drive node under control of a compensation control signal.

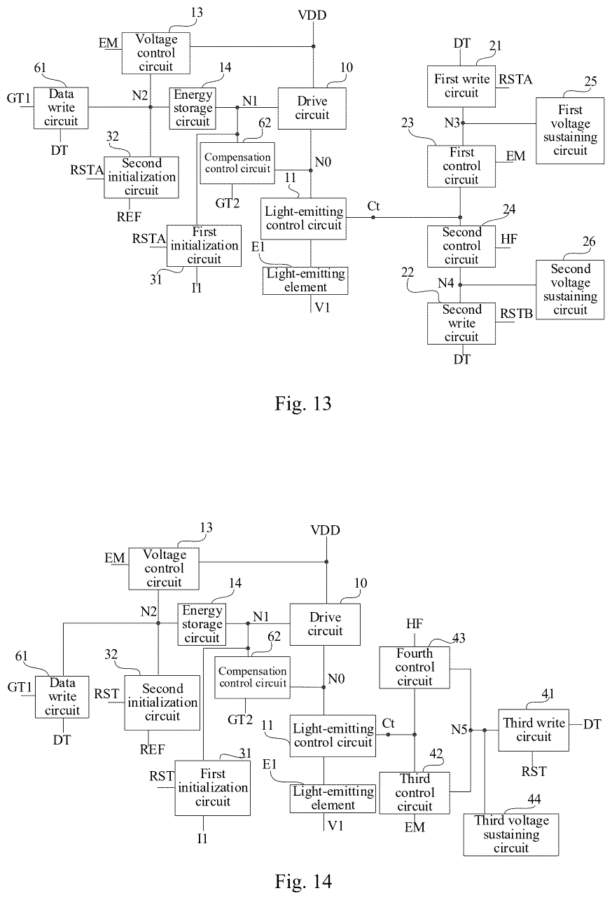

As shown in FIG. 13, on the basis of at least one embodiment of the pixel circuit shown in FIG. 7, the pixel circuit according to at least one embodiment of the present disclosure further includes a data write circuit 61 and a compensation control circuit 62.

The data write circuit 61 is electrically connected to a write control terminal GT1, the data line DT, and the second node N2, and is configured to control connection between the data line DT and the second node N2 under control of a write control signal provided by the write control terminal GT.

The compensation control circuit 62 is electrically connected to a compensation control terminal GT2, the first node N1, and the drive node NO, and is configured to control connection between the first node N1 and the drive node NO under control of a compensation control signal provided by the compensation control terminal GT2.

As shown in FIG. 14, on the basis of at least one embodiment of the pixel circuit shown in FIG. 11, the pixel circuit according to at least one embodiment of the present disclosure further includes a data write circuit 61 and a compensation control circuit 62.

The data write circuit 61 is electrically connected to a write control terminal GT1, the data line DT, and the second node N2, and is configured to control connection between the data line DT and the second node N2 under control of a write control signal provided by the write control terminal GT.

The compensation control circuit 62 is electrically connected to a compensation control terminal GT2, the first node N1, and the drive node NO, and is configured to control connection between the first node N1 and the drive node NO under control of a compensation control signal provided by the compensation control terminal GT2.

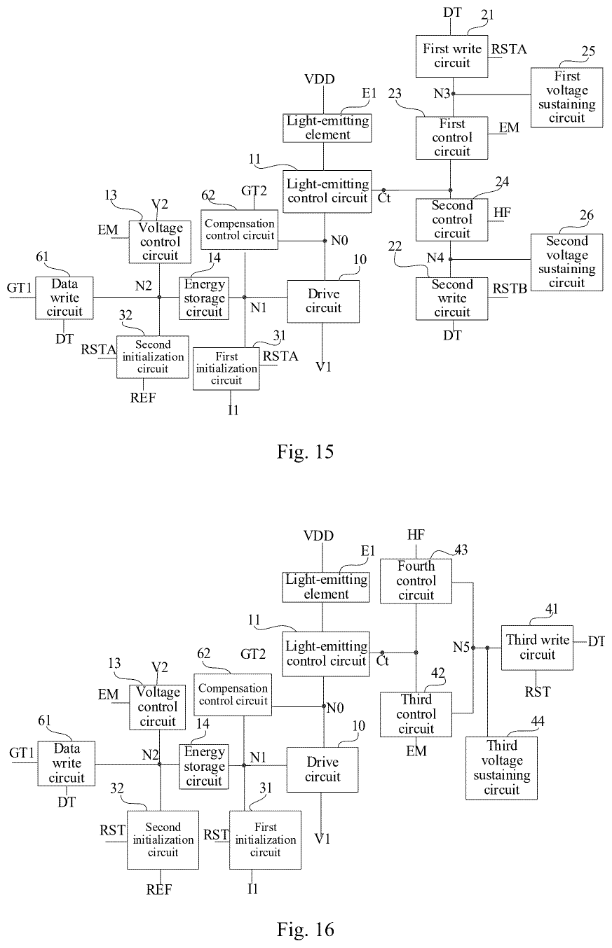

As shown in FIG. 15, on the basis of at least one embodiment of the pixel circuit shown in FIG. 8, the pixel circuit according to at least one embodiment of the present disclosure further includes a data write circuit 61 and a compensation control circuit 62.

The data write circuit 61 is electrically connected to a write control terminal GT1, the data line DT, and the second node N2, and is configured to control connection between the data line DT and the second node N2 under control of a write control signal provided by the write control terminal GT.

The compensation control circuit 62 is electrically connected to a compensation control terminal GT2, the first node N1, and the drive node N0, and is configured to control connection between the first node N1 and the drive node N0 under control of a compensation control signal provided by the compensation control terminal GT2.

As shown in FIG. 16, on the basis of at least one embodiment of the pixel circuit shown in FIG. 12, the pixel circuit according to at least one embodiment of the present disclosure further includes a data write circuit 61 and a compensation control circuit 62.

The data write circuit 61 is electrically connected to a write control terminal GT1, the data line DT, and the second node N2, and is configured to control connection between the data line DT and the second node N2 under control of a write control signal provided by the write control terminal GT.

The compensation control circuit 62 is electrically connected to a compensation control terminal GT2, the first node N1, and the drive node NO, and is configured to control connection between the first node N1 and the drive node NO under control of a compensation control signal provided by the compensation control terminal GT2.

Optionally, the first write circuit includes a first transistor, the second write circuit includes a second transistor, the first control circuit includes a third transistor, and the second control circuit includes a fourth transistor;
a gate electrode of the first transistor is electrically connected to the first initial control terminal, a first electrode of the first transistor is electrically connected to the data line, and a second electrode of the first transistor is electrically connected to the third node;
a gate electrode of the second transistor is electrically connected to the second initial control terminal, a first electrode of the second transistor is electrically connected to the data line, and a second electrode of the second transistor is electrically connected to the fourth node;
a gate electrode of the third transistor is electrically connected to the third node, a first electrode of the third transistor is electrically connected to the light-emitting control terminal, and a second electrode of the third transistor is electrically connected to the control node; and
a gate electrode of the fourth transistor is electrically connected to the fourth node, a first electrode of the fourth transistor is electrically connected to the light-emitting control voltage terminal, and a second electrode of the fourth transistor is electrically connected to the control node.

Optionally, the first voltage sustaining circuit includes a first capacitor, and the second voltage sustaining circuit includes a second capacitor;
a first terminal of the first capacitor is electrically connected to the third node, and a second terminal of the first capacitor is electrically connected to a direct current voltage terminal; and
a first terminal of the second capacitor is electrically connected to the fourth node, and a second terminal of the second capacitor is electrically connected to the direct current voltage terminal.

Optionally, the direct current voltage terminal may be, but is not limited to, a ground terminal, a low voltage terminal, or a common electrode voltage terminal.

Optionally, the first initialization circuit includes a fifth transistor, and the second initialization circuit includes a sixth transistor;
a gate electrode of the fifth transistor is electrically connected to the first initial control terminal, a first electrode of the fifth transistor is electrically connected to the initial voltage terminal, and a second electrode of the fifth transistor is electrically connected to the first node; and
a gate electrode of the sixth transistor is electrically connected to the first initial control terminal, a first electrode of the sixth transistor is electrically connected to the reference voltage terminal, and a second electrode of the sixth transistor is electrically connected to the second node.

Optionally, the third write circuit includes a seventh transistor, the third control circuit includes an eighth transistor, and the fourth control circuit includes a ninth transistor;
a gate electrode of the seventh transistor is electrically connected to the initial control terminal, a first electrode of the seventh transistor is electrically connected to the data line, and a second electrode of the seventh transistor is electrically connected to the fifth node;
a gate electrode of the eighth transistor is electrically connected to the fifth node, a first electrode of the eighth transistor is electrically connected to the light-emitting control terminal, and a second electrode of the eighth transistor is electrically connected to the control node; and
a gate electrode of the ninth transistor is electrically connected to the fifth node, a first electrode of the ninth transistor is electrically connected to the light-emitting control voltage terminal, and a second electrode of the ninth transistor is electrically connected to the control node.

Optionally, the third voltage sustaining circuit includes a third capacitor; and
a first terminal of the third capacitor is electrically connected to the fifth node, and a second terminal of the third capacitor is electrically connected to a direct current voltage terminal.

Optionally, the first initialization circuit includes a fifth transistor, and the second initialization circuit includes a sixth transistor;
a gate electrode of the fifth transistor is electrically connected to the initial control terminal, a first electrode of the fifth transistor is electrically connected to the initial voltage terminal, and a second electrode of the fifth transistor is electrically connected to the first node; and
a gate electrode of the sixth transistor is electrically connected to the initial control terminal, a first electrode of the sixth transistor is electrically connected to the reference voltage terminal, and the second electrode of the fifth transistor is electrically connected to the second node.

Optionally, the drive circuit includes a drive transistor, and the light-emitting control circuit includes a tenth transistor;
a gate electrode of the drive transistor is electrically connected to the first node, a first electrode of the drive transistor is electrically connected to the power supply voltage terminal, and a second electrode of the drive transistor is electrically connected to the drive node; and
a gate electrode of the tenth transistor is electrically connected to the light-emitting control terminal, a first electrode of the tenth transistor is electrically connected to the power supply voltage terminal, and a second electrode of the tenth transistor is electrically connected to the first electrode of the light-emitting element.

Optionally, the drive circuit includes a drive transistor, and the light-emitting control circuit includes a tenth transistor;
a gate electrode of the drive transistor is electrically connected to the first node, a first electrode of the drive transistor is electrically connected to the drive node, and a second electrode of the drive transistor is electrically connected to the first voltage terminal; and
a gate electrode of the tenth transistor is electrically connected to the light-emitting control terminal, a first electrode of the tenth transistor is electrically connected to the second electrode of the light-emitting element, and a second electrode of the tenth transistor is electrically connected to the drive node.

Optionally, the energy storage circuit includes a storage capacitor, and the voltage control circuit includes an eleventh transistor;
a first terminal of the storage capacitor is electrically connected to the first node, and a second terminal of the storage capacitor is electrically connected to the second node; and
a gate electrode of the eleventh transistor is electrically connected to the light-emitting control terminal, a first electrode of the eleventh transistor is electrically connected to the second voltage terminal, and a second electrode of the eleventh transistor is electrically connected to the second node.

Optionally, the data write circuit includes a twelfth transistor, and the compensation control circuit includes a thirteenth transistor;
a gate electrode of the twelfth transistor is electrically connected to the write control terminal, a first electrode of the twelfth transistor is electrically connected to the data line, and a second electrode of the twelfth transistor is electrically connected to the second node; and
a gate electrode of the thirteenth transistor is electrically connected to the compensation control terminal, a first electrode of the thirteenth transistor is electrically connected to the first node, and a second electrode of the thirteenth transistor is electrically connected to the drive node.

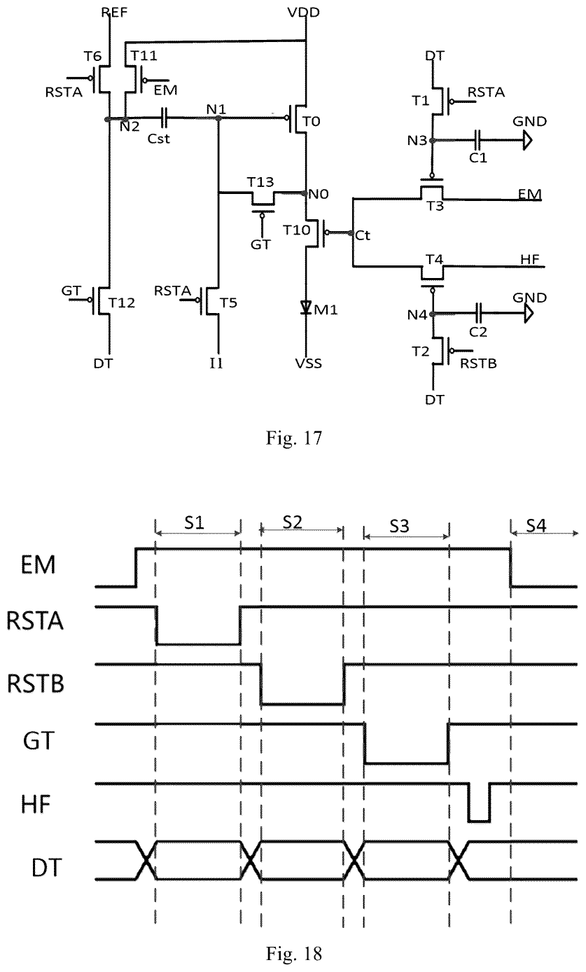

As shown in FIG. 17, on the basis of at least one embodiment of the pixel circuit shown in FIG. 13, the light-emitting element is a micro light-emitting diode M1;
the first write circuit includes a first transistor T1, the second write circuit includes a second transistor T2, the first control circuit includes a third transistor T3, and the second control circuit includes a fourth transistor T4.

A gate electrode of the first transistor T1 is electrically connected to the first initial control terminal RSTA, a source electrode of the first transistor T1 is electrically connected to the data line DT, and a drain electrode of the first transistor T1 is electrically connected to the third node N3.

A gate electrode of the second transistor T2 is electrically connected to the second initial control terminal RSTB, a source electrode of the second transistor T2 is electrically connected to the data line DT, and a drain electrode of the second transistor T2 is electrically connected to the fourth node N4.

A gate electrode of the third transistor T3 is electrically connected to the third node N3, a source electrode of the third transistor T3 is electrically connected to the light-emitting control terminal EM, and a drain electrode of the third transistor T3 is electrically connected to the control node Ct.

A gate electrode of the fourth transistor T4 is electrically connected to the fourth node N4, a source electrode of the fourth transistor T4 is electrically connected to the light-emitting control voltage terminal HF, and a drain electrode of the fourth transistor T4 is electrically connected to the control node Ct.

The first voltage sustaining circuit includes a first capacitor C1, and the second voltage sustaining circuit includes a second capacitor C2.

A first terminal of the first capacitor C1 is electrically connected to the third node N3, and a second terminal of the first capacitor C1 is electrically connected to a ground terminal GND.

A first terminal of the second capacitor C2 is electrically connected to the fourth node N4, and a second terminal of the second capacitor C2 is electrically connected to the ground terminal GND.

The first initialization circuit includes a fifth transistor T5, and the second initialization circuit includes a sixth transistor T6.

A gate electrode of the fifth transistor T5 is electrically connected to the first initial control terminal RSTA, a source electrode of the fifth transistor T5 is electrically connected to the initial voltage terminal I1, and a drain electrode of the fifth transistor T5 is electrically connected to the first node N1.

A gate electrode of the sixth transistor T6 is electrically connected to the first initial control terminal RSTA, a source electrode of the sixth transistor T6 is electrically connected to the reference voltage terminal REF, and a drain electrode of the sixth transistor T6 is electrically connected to the second node N2.

The drive circuit includes a drive transistor T0, the energy storage circuit includes a storage capacitor Cst, the light-emitting control circuit includes a tenth transistor T10, and the voltage control circuit includes an eleventh transistor T11.

A gate electrode of the drive transistor T0 is electrically connected to the first node N1, a source electrode of the drive transistor T0 is electrically connected to the power supply voltage terminal VDD, and a drain electrode of the drive transistor T0 is electrically connected to the drive node N0.

A first terminal of the storage capacitor Cst is electrically connected to a first node N1, and a second terminal of the storage capacitor Cst is electrically connected to a second node N2.

The gate electrode of the tenth transistor T10 is electrically connected to the control node Ct, the source electrode of the tenth transistor T10 is electrically connected to the drive node N0, and the drain electrode of the tenth transistor T10 is electrically connected to the anode of the micro light-emitting diode M1; the cathode of the micro light-emitting diode M1 is electrically connected to the low voltage terminal VSS.

A gate electrode of the eleventh transistor T11 is electrically connected to the light-emitting control terminal EM, a source electrode of the eleventh transistor T11 is electrically connected to the power supply voltage terminal VDD, and a drain electrode of the eleventh transistor T11 is electrically connected to the second node N2.

The data write circuit includes a twelfth transistor T12, and the compensation control circuit includes a thirteenth transistor T13; the write control terminal and the compensation control terminal are both a scanning terminal GT.

A gate electrode of the twelfth transistor T12 is electrically connected to the scanning terminal GT, a source electrode of the twelfth transistor T12 is electrically connected to the data line DT, and a drain electrode of the twelfth transistor T12 is electrically connected to the second node N2.

A gate electrode of the thirteenth transistor T13 is electrically connected to the scanning terminal GT, a source electrode of the thirteenth transistor T13 is electrically connected to the first node N1, and a drain electrode of the thirteenth transistor T13 is electrically connected to the drive node N0.

In at least one embodiment of the pixel circuit shown in FIG. 17, all transistors are p-type transistors, but this is not a limitation.

In at least one embodiment of the pixel circuit shown in FIG. 17, the second voltage terminal is power supply voltage terminal VDD.

In at least one embodiment of the pixel circuit shown in FIG. 17, the voltage value of Vref may be greater than or equal to −3V and less than or equal to the voltage value of the power supply voltage provided by VDD, and the voltage value of Vil may be greater than or equal to −3V and less than or equal to the power supply voltage value, where the power supply voltage value may be the voltage value of the power supply voltage provided by VDD. For example, Vref may have a voltage value of 0V, and Vil may have a voltage value of 0V, but this is not a limitation.

Optionally, the power supply voltage provided by VDD may have a voltage value of 14.6V, and the low voltage signal provided by VSS may have a voltage value of 0V. The voltage value of the power supply voltage may be greater than or equal to 12V and less than or equal to 18V, and the voltage value of the low voltage signal provided by the VSS may be greater than or equal to −3V and less than or equal to 1V, but is not limited thereto.

When at least one embodiment of the pixel circuit shown in FIG. 17 of the present disclosure is operating, in a reset stage S1, a selection stage S2, and a data write and compensation stage S3, the VDD inputs a first power supply voltage VDD1, no current flows through the power supply voltage terminal VDD, and the voltage drop is substantially zero. In a light-emitting stage S4, a drive current required by each pixel circuit flows through the power supply voltage terminal VDD, an IR voltage drop is generated, the power supply voltage terminal for the circuit of a certain pixel at a distal end provides a second power supply voltage VDD2, and VDD2=VDD-Vdrop, where Vdrop is the voltage drop.

As shown in FIG. 18, when at least one embodiment of the pixel circuit shown in FIG. 17 of the present disclosure is operating, the display period includes a reset stage S1, a selection stage S2, a data write and compensation stage S3, and a light-emitting stage S4, which are arranged successively.

In the reset stage S1, the EM provides a high voltage signal, the RSTA provides a low voltage signal, the RSTB provides a high voltage signal, the GT provides a high voltage signal, the HF provides a high voltage signal, and the DT provides a first data voltage Vdata_S1. T5 and T6 are turned on, to reset the nodes at two terminals of the Cst; at this moment, the potential of N2 is Vref, and the potential of N1 is Vint. At the same time, T1 is turned on, and the Vdata_S1 is written into N3 through T1, and when displaying a medium-to-high gray level, the Vdata_S1 is a low voltage signal, so that T3 is turned on, and a light-emitting control signal provided by EM is written into a gate electrode of T10; when displaying a low gray level, Vdata_S1 is a high voltage signal, and T3 is turned off.

In the selection stage S2, the EM provides a high voltage signal, the RSTA provides a high voltage signal, the RSTB provides a low voltage signal, the GT provides a high voltage signal, the HF provides a high voltage signal, and the DT provides a second data voltage Vdata_S2. T4 is turned on, and the Vdata_S2 is written into N4 through T4, and when displaying a medium-to-high gray level, the Vdata_S2 is a high voltage signal, so that T4 is turned off; when displaying a low gray level, the Vdata_S2 is a low voltage signal, the T4 is turned on, the light-emitting control voltage provided by the HF is written into the gate electrode of T10, and the light-emitting control voltage provided by the HF is a high frequency pulse signal; when displaying a middle-to-high gray level, the light-emitting control signal provided by EM is written into the gate electrode of T10, and MI emits light for a long time; when displaying a low gray level, a light-emitting control voltage provided by HF is written into a gate electrode of T10, to realize PWM (pulse width modulation) modulation, and the light-emitting control voltage is a high frequency PWM signal, which may improve the problem of poor uniformity of low gray levels of micro light-emitting diodes, reduce visual fatigue and improve viewing comfort; the potential of N1 and the potential of N2 remain unchanged from the previous moment.

In the data write and compensation stage S3, GT provides a low voltage signal, T12 is turned on, DT provides a display data voltage Vdata, and the Vdata charges N1 through TO and T13, so that the potential of N1 becomes VDD1 +Vth, where Vth is a threshold voltage of TO.

In the light-emitting stage S4, the EM provides a low voltage signal, T11 is turned on, VDD2 is written into N2, and the potential of N1 becomes VDD1+Vth+VDD2−Vdata through self-booting effect of Cst; the gate-source voltage of TO is VDD1+Vth−Vdata, and the drive current Id flowing through M1 is equal to K(VDD1−Vdata)², so as to be able to eliminate the influence of the IR voltage drop; where K is the current coefficient of T0.

When displaying a middle-to-high gray level, the gate electrode of the T10 is connected to the light-emitting control signal provided by the EM, the T10 is turned on, and the M1 emits light.

When displaying a low gray level, the gate electrode of the T10 is connected to the light-emitting control voltage provided by the HF; when HF provides a low voltage signal, T10 is turned on and M1 emits light, achieving PWM display.

In the operation of at least one embodiment of the pixel circuit shown in FIG. 17 of the present disclosure,
in the reset stage S1, the potential of N1 is Vint, and the potential of N2 is Vref;
in the selection stage S2, the potential of N1 is Vint, and the potential of N2 is Vref;
in the data write and compensation stage S3, the potential of N1 is Vdata, and the potential of N2 is VDD1+Vth; Vth is the threshold voltage of T0; and in the light-emitting stage S4, the potential of N1 is VDD2, and the potential of N2 is VDD1+Vth+VDD2−Vdata.

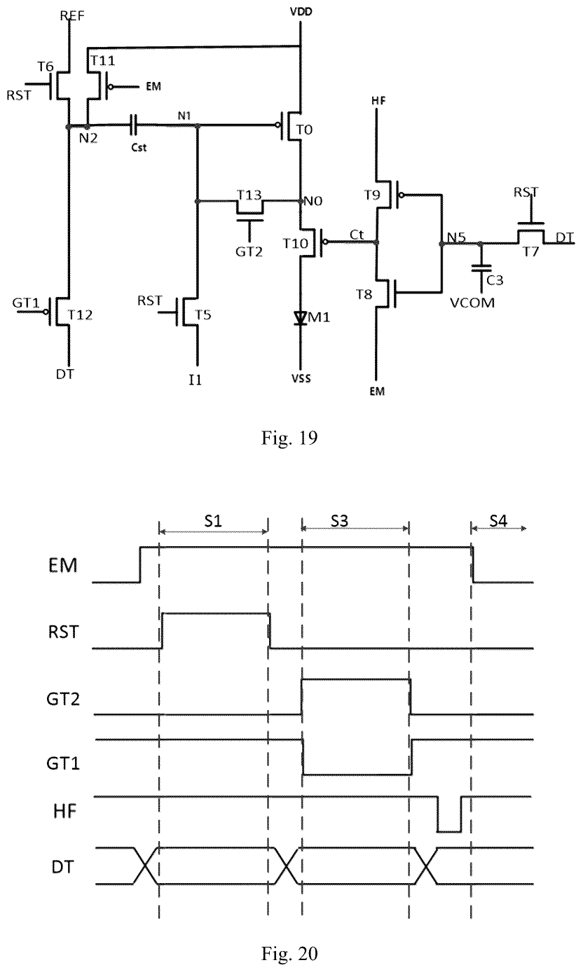

As shown in FIG. 19, on the basis of at least one embodiment of the pixel circuit shown in FIG. 14, the light-emitting element is a micro light-emitting diode M1.

The third write circuit includes a seventh transistor T7, the third control circuit includes an eighth transistor T8, and the fourth control circuit includes a ninth transistor T9.

A gate electrode of the seventh transistor T7 is electrically connected to the initial control terminal RST, a source electrode of the seventh transistor T7 is electrically connected to the data line DT, and a drain electrode of the seventh transistor T7 is electrically connected to the fifth node N5.

A gate electrode of the eighth transistor T8 is electrically connected to the fifth node N5, a source electrode of the eighth transistor T8 is electrically connected to the light-emitting control terminal EM, and a drain electrode of the eighth transistor T8 is electrically connected to the control node Ct.

A gate electrode of the ninth transistor T9 is electrically connected to the fifth node N5, a source electrode of the ninth transistor T9 is electrically connected to the light-emitting control voltage terminal HF, and a drain electrode of the ninth transistor T9 is electrically connected to the control node Ct.

The third voltage sustaining circuit includes a third capacitor C3; and a first terminal of the third capacitor C3 is electrically connected to the fifth node N5, and a second terminal of the third capacitor C3 is electrically connected to a common electrode voltage terminal VCOM.

The first initialization circuit includes a fifth transistor T5, and the second initialization circuit includes a sixth transistor T6.

A gate electrode of the fifth transistor T5 is electrically connected to the initial control terminal RST, a source electrode of the fifth transistor T5 is electrically connected to the initial voltage terminal I1, and a drain electrode of the fifth transistor T5 is electrically connected to the first node N1; the initial voltage terminal I1 is configured to provide an initial voltage Vint.

A gate electrode of the sixth transistor T6 is electrically connected to the initial control terminal RST, a source electrode of the sixth transistor T6 is electrically connected to the reference voltage terminal REF, and a drain electrode of the sixth transistor T6 is electrically connected to the second node N2; and the reference voltage terminal REF is configured to provide a reference voltage Vref.

The drive circuit includes a drive transistor T0, the energy storage circuit includes a storage capacitor Cst, the light-emitting control circuit includes a tenth transistor T10, and the voltage control circuit includes an eleventh transistor T11.

A gate electrode of the drive transistor T0 is electrically connected to the first node N1, a source electrode of the drive transistor T0 is electrically connected to the power supply voltage terminal VDD, and a drain electrode of the drive transistor T0 is electrically connected to the drive node N0.

A first terminal of the storage capacitor Cst is electrically connected to a first node N1, and a second terminal of the storage capacitor Cst is electrically connected to a second node N2.

The gate electrode of the tenth transistor T10 is electrically connected to the control node Ct, the source electrode of the tenth transistor T10 is electrically connected to the drive node N0, and the drain electrode of the tenth transistor T10 is electrically connected to the anode of the micro light-emitting diode M1; the cathode of M1 is electrically connected to the low voltage terminal VSS.

A gate electrode of the eleventh transistor T11 is electrically connected to the light-emitting control terminal EM, a source electrode of the eleventh transistor T11 is electrically connected to the power supply voltage terminal VDD, and a drain electrode of the eleventh transistor T11 is electrically connected to the second node N2.

The data write circuit includes a twelfth transistor T12, and the compensation control circuit includes a thirteenth transistor T13.

A gate electrode of the twelfth transistor T12 is electrically connected to the write control terminal GT1, a source electrode of the twelfth transistor T12 is electrically connected to the data line DT, and a drain electrode of the twelfth transistor T12 is electrically connected to the second node N2.

A gate electrode of the thirteenth transistor T13 is electrically connected to the compensation control terminal GT2, a source electrode of the thirteenth transistor T13 is electrically connected to the first node N1, and a drain electrode of the thirteenth transistor T13 is electrically connected to the drive node N0.

In at least one embodiment of the pixel circuit shown in FIG. 19 of the present disclosure, T0, T9, T10, T11, and T12 are all p-type transistors, and T6, T7, T8, T5, and T13 are all n-type transistors.

In at least one embodiment of the pixel circuit shown in FIG. 19, the second voltage terminal is power supply voltage terminal VDD.

In at least one embodiment of the pixel circuit shown in FIG. 19, the voltage value of Vref may be greater than or equal to −3V and less than or equal to the voltage value of the power supply voltage provided by VDD, and the voltage value of Vil may be greater than or equal to −3V and less than or equal to the power supply voltage value, and the power supply voltage value may be the voltage value of the power supply voltage provided by VDD. For example, Vref may have a voltage value of 0V, and Vil may have a voltage value of 0V, but this is not a limitation.

Optionally, the power supply voltage provided by VDD may have a voltage value of 14.6V, and the low voltage signal provided by VSS may have a voltage value of 0V. The voltage value of the power supply voltage may be greater than or equal to 12V and less than or equal to 18V, and the voltage value of the low voltage signal provided by the VSS may be greater than or equal to −3V and less than or equal to 1V, but is not limited thereto.

As shown in FIG. 20, when at least one embodiment of the pixel circuit shown in FIG. 19 of the present disclosure is operating, the display period may include a reset stage S1, a data write and compensation stage S3, and a light-emitting stage S4, which are arranged successively.

In the reset stage S1, the RST provides a high voltage signal, the EM provides a high voltage signal, the GT2 provides a low voltage signal, the GT1 provides a high voltage signal, the HF provides a high voltage signal, and the DT provides a first data voltage Vdata_S1; T5 and T6 are turned on, to reset the potential of N1 and the potential of N2, and at this moment, the potential of N1 is Vint, and the potential of N2 is Vref.

At the same time, T2 is turned on, and Vdata_S1 is written into N5 through T2.

When displaying a middle-to-high gray level, Vdata_S1 is a high voltage signal, T1 is turned off, T3 is turned on, and a light-emitting control signal provided by EM is written into a gate electrode of T10.

When displaying a low gray level, the Vdata_S1 is a low voltage signal, Tl is turned on, T3 is turned off, and a light-emitting control terminal voltage provided by the HF is written into the gate electrode of T10.

In the data write and compensation stage S3, GT1 provides a low voltage signal, GT2 provides a high voltage signal, EM provides a high voltage signal, RST provides a low voltage signal, HF provides a high voltage signal, DT provides a display data voltage Vdata, and VDD charges N1 through T0 and T13 until the potential of N1 is VDD1+Vth, where Vth is a threshold voltage of T0.

In the light-emitting stage S4, the EM provides a low voltage signal, T11 is turned on, VDD2 is written into N2, and the potential of N1 becomes VDD1+Vth+VDD2−Vdata through self-booting effect of Cst; the gate-source voltage of T0 is VDD1+Vth−Vdata, and the drive current Id flowing through M1 is equal to K(VDD1−Vdata)², so as to be able to eliminate the influence of the IR voltage drop; where K is the current coefficient of T0.

When displaying a middle-to-high gray level, the gate electrode of the T10 is connected to the light-emitting control signal provided by the EM, the T10 is turned on, and the M1 emits light.

When displaying a low gray level, the gate electrode of the T10 is connected to the light-emitting control voltage provided by HF, and when HF provides a low voltage signal, T10 is turned on, realizing PWM display.

In the operation of at least one embodiment of the pixel circuit shown in FIG. 19 of the present disclosure,
in the reset stage S1, the potential of N1 is Vint, and the potential of N2 is Vref;
in the data write and compensation stage S3, the potential of N1 is Vdata, and the potential of N2 is VDD1+Vth; Vth is the threshold voltage of T0; and in the light-emitting stage S4, the potential of N1 is VDD2, and the potential of N2 is VDD1+Vth+VDD2−Vdata.

In the operation of at least one embodiment of the pixel circuit shown in FIG. 19 of the present disclosure, in the light-emitting stage S4, the gate-source voltage Vgs of T0 is equal to VDD1+Vth+VDD2−Vdata−VDD2, and Vgs is equal to VDD1+ Vth−Vdata; the drive current Id through M1 is equal to K×(VDD1−Vdata)², so as to be able to eliminate the influence of the IR voltage drop.

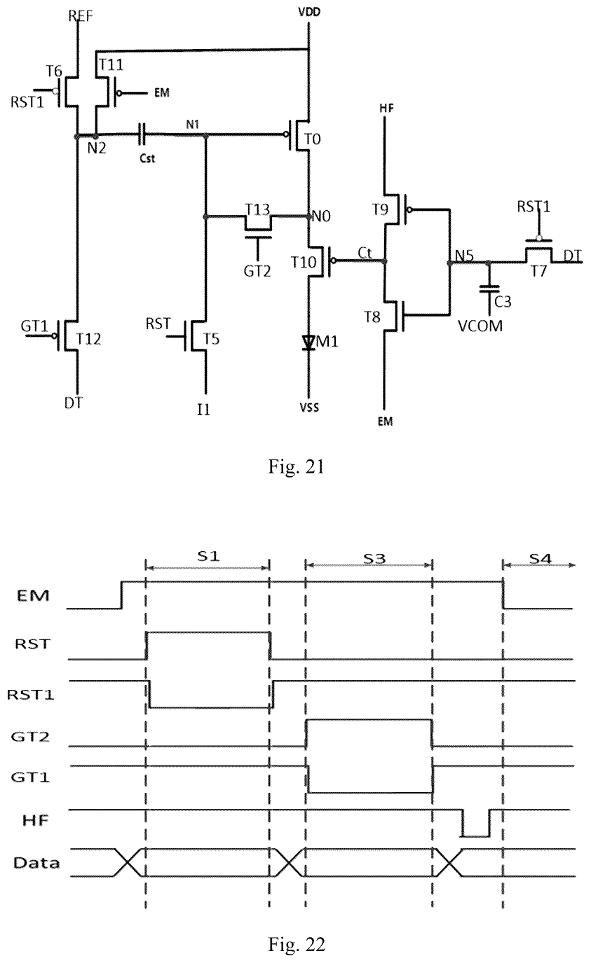

At least one embodiment of the pixel circuit shown in FIG. 21 of the present disclosure differs from at least one embodiment of the pixel circuit shown in FIG. 19 of the present disclosure in that: T6 and T7 are p-type transistors; and both the gate electrode of T6 and the gate electrode of T7 are electrically connected to the reset control voltage terminal RST1.

FIG. 22 is a timing diagram of operation of at least one embodiment of the pixel circuit shown in FIG. 21 of the present disclosure, where the reset control voltage signal provided by RST1 is inverted from the reset control signal provided by RST in FIG. 11.

In at least one embodiment of the pixel circuit shown in FIG. 19 of the present disclosure, T1 may be an n-type transistor, and T3 may be a p-type transistor.

The transistor type of T1 is opposite to the transistor type of T3 so as to realize an inverter voltage writing function; when T1 is an n-type transistor and T3 is a p-type transistor, in a case of displaying a medium-to-high gray level, the Vdata is a low voltage signal; and in a case of displaying a low gray level, Vdata is a high voltage signal.

In at least one embodiment of the pixel circuit shown in FIG. 19 of the present disclosure, T12 may also be replaced with a p-type transistor.

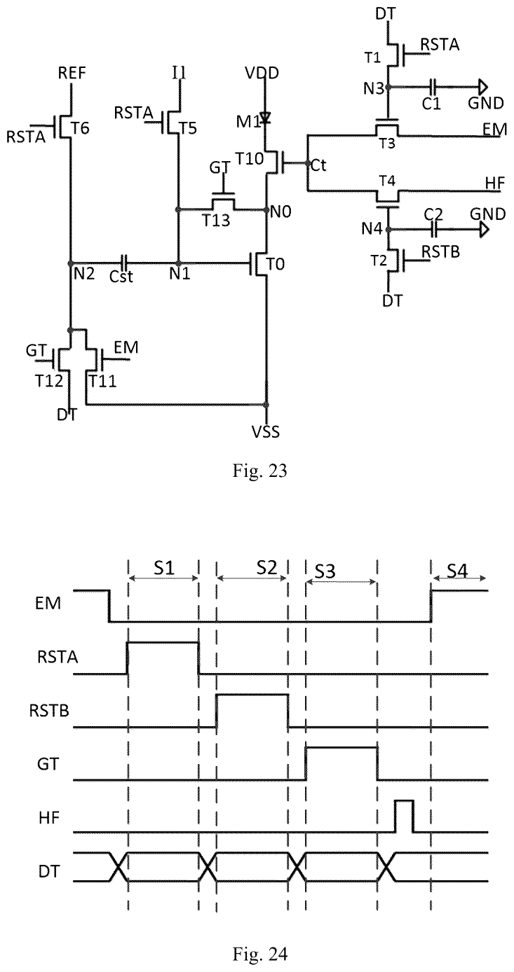

As shown in FIG. 23, on the basis of at least one embodiment of the pixel circuit shown in FIG. 15,
the light-emitting element is a micro light-emitting diode M1;
the first write circuit includes a first transistor T1, the second write circuit includes a second transistor T2, the first control circuit includes a third transistor T3, and the second control circuit includes a fourth transistor T4;
a gate electrode of the first transistor T1 is electrically connected to the first initial control terminal RSTA, a source electrode of the first transistor T1 is electrically connected to the data line DT, and a drain electrode of the first transistor T1 is electrically connected to the third node N3;
a gate electrode of the second transistor T2 is electrically connected to the second initial control terminal RSTB, a source electrode of the second transistor T2 is electrically connected to the data line DT, and a drain electrode of the second transistor T2 is electrically connected to the fourth node N4;
a gate electrode of the third transistor T3 is electrically connected to the third node N3, a source electrode of the third transistor T3 is electrically connected to the light-emitting control terminal EM, and a drain electrode of the third transistor T3 is electrically connected to the control node Ct;
a gate electrode of the fourth transistor T4 is electrically connected to the fourth node N4, a source electrode of the fourth transistor T4 is electrically connected to the light-emitting control voltage terminal HF, and a drain electrode of the fourth transistor T4 is electrically connected to the control node Ct;
the first voltage sustaining circuit includes a first capacitor C1, and the second voltage sustaining circuit includes a second capacitor C2;
a first terminal of the first capacitor C1 is electrically connected to the third node N3, and a second terminal of the first capacitor C1 is electrically connected to a ground terminal GND;
a first terminal of the second capacitor C2 is electrically connected to the fourth node N4, and a second terminal of the second capacitor C2 is electrically connected to the ground terminal GND;
the first initialization circuit includes a fifth transistor T5, and the second initialization circuit includes a sixth transistor T6;
a gate electrode of the fifth transistor T5 is electrically connected to the first initial control terminal RSTA, a source electrode of the fifth transistor T5 is electrically connected to the initial voltage terminal I1, and a drain electrode of the fifth transistor T5 is electrically connected to the first node N1;
a gate electrode of the sixth transistor T6 is electrically connected to the first initial control terminal RSTA, a source electrode of the sixth transistor T6 is electrically connected to the reference voltage terminal REF, and a drain electrode of the sixth transistor T6 is electrically connected to the second node N2;
the drive circuit includes a drive transistor T0, the energy storage circuit includes a storage capacitor Cst, the light-emitting control circuit includes a tenth transistor T10, and the voltage control circuit includes an eleventh transistor T11;
a gate electrode of the drive transistor T0 is electrically connected to the first node N1, a source electrode of the drive transistor T0 is electrically connected to the drive node N0, and a drain electrode of the drive transistor T0 is electrically connected to a low voltage terminal VSS;
a first terminal of the storage capacitor Cst is electrically connected to a first node N1, and a second terminal of the storage capacitor Cst is electrically connected to a second node N2;
the anode of the micro light-emitting diode M1 is electrically connected to a power supply voltage terminal VDD;
a gate electrode of the tenth transistor T10 is electrically connected to the control node Ct, a source electrode of the tenth transistor T10 is electrically connected to a cathode of the micro light-emitting diode M1, and a drain electrode of the tenth transistor T10 is electrically connected to the drive node N0; the cathode of the micro light-emitting diode M1 is electrically connected to the low voltage terminal VSS;
a gate electrode of the eleventh transistor T11 is electrically connected to the light-emitting control terminal EM, a source electrode of the eleventh transistor T11 is electrically connected to the low voltage terminal VSS, and a drain electrode of the eleventh transistor T11 is electrically connected to the second node N2;
the data write circuit includes a twelfth transistor T12, and the compensation control circuit includes a thirteenth transistor T13; the write control terminal and the compensation control terminal are both the scanning terminal GT;
a gate electrode of the twelfth transistor T12 is electrically connected to the scanning terminal GT, a source electrode of the twelfth transistor T12 is electrically connected to the data line DT, and a drain electrode of the twelfth transistor T12 is electrically connected to the second node N2; and
a gate electrode of the thirteenth transistor T13 is electrically connected to the scanning terminal GT, a source electrode of the thirteenth transistor T13 is electrically connected to the first node N1, and a drain electrode of the thirteenth transistor T13 is electrically connected to the drive node N0.

In at least one embodiment of the pixel circuit shown in FIG. 23, all transistors are n-type transistors, but this is not a limitation.

In at least one embodiment of the pixel circuit shown in FIG. 23, T0 needs to be an n-type transistor, and other transistors may be replaced with p-type transistors.

In at least one embodiment of the pixel circuit shown in FIG. 23,

In at least one embodiment of the pixel circuit shown in FIG. 23, the second voltage terminal is a low voltage terminal VSS.

In the operation of least one embodiment of the pixel circuit shown in FIG. 23 of the present disclosure, in a reset stage S1, a selection stage S2, and a data write and compensation stage S3, a low voltage terminal VSS provides a first low voltage VSS1, no current flows through the low voltage terminal VSS, and a voltage drop is substantially zero; in the light-emitting stage S4, a drive current required by each pixel circuit flows through the low voltage terminal VSS, an IR voltage drop is generated, the low voltage terminal for the circuit of a certain pixel at a distal end provides a second low voltage VSS2, and VSS2=VDD−Vdrop, where Vdrop is the voltage drop.

In at least one embodiment of the pixel circuit shown in FIG. 23, the voltage value of Vref may be greater than or equal to −3V and less than or equal to the voltage value of the power supply voltage provided by VDD, the voltage value of Vil may be the same as the voltage value of the power supply voltage provided by VDD, or, the voltage value of Vil may be less than the voltage value of the power supply voltage provided by VDD, and the absolute value of the difference between the voltage value of Vil and the voltage value of the power supply voltage provided by VDD is less than or equal to 3V.

Optionally, the power supply voltage provided by VDD may have a voltage value of 14.6V, and the low voltage signal provided by VSS may have a voltage value of 0V. The voltage value of the power supply voltage may be greater than or equal to 12V and less than or equal to 18V, and the voltage value of the low voltage signal provided by the VSS may be greater than or equal to −3V and less than or equal to 1V, but is not limited thereto.

As shown in FIG. 24, when at least one embodiment of the pixel circuit shown in FIG. 23 of the present disclosure is operating, the display period includes a reset stage S1, a selection stage S2, a data write and compensation stage S3, and a light-emitting stage S4, which are arranged successively.

In the reset stage S1, the EM provides a low voltage signal, the RSTA provides a high voltage signal, the RSTB provides a low voltage signal, the GT provides a low voltage signal, the HF provides a low voltage signal, and the DT provides a first data voltage Vdata_S1; T5 and T6 are turned on, to reset the nodes at two terminal of the Cst, and at this moment, the potential of N2 is Vref, and the potential of N1 is Vint; at the same time, T1 is turned on, and the Vdata_S1 is written into N3 through T1, and when displaying a medium-to-high gray level, the Vdata_S1 is a high voltage signal, so that T3 is turned on, and a light-emitting control signal provided by EM is written into a gate electrode of T10; when displaying a low gray level, Vdata_S1 is a low voltage signal and T3 is turned off.

In the selection stage S2, the EM provides a low voltage signal, the RSTA provides a low voltage signal, the RSTB provides a high voltage signal, the GT provides a low voltage signal, the HF provides a low voltage signal, and the DT provides a second data voltage Vdata_S2; T4 is turned on, Vdata_S2 written into N4 through T4, and when displaying a medium-to-high gray level, the Vdata_S2 is a low voltage signal, so that T4 is turned off, when displaying a low gray level, the Vdata_S2 is a high voltage signal, the T4 is turned on, the light-emitting control voltage provided by the HF is written into the gate electrode of T10, and the light-emitting control voltage provided by the HF is a high frequency pulse signal; when displaying a middle-to-high gray level, the light-emitting control signal provided by EM is written into the gate electrode of T10, and M1 emits light for a long time; when displaying a low gray level, a light-emitting control voltage provided by HF is written into a gate electrode of T10 to realize PWM (pulse width modulation) modulation, and the light-emitting control voltage is a high frequency PWM signal, which may improve the problem of poor uniformity of low gray levels of micro light-emitting diodes, reduce visual fatigue and improve viewing comfort; the potential of N1 and the potential of N2 remain unchanged from the previous moment.

In the data write and compensation stage S3, GT provides a high voltage signal, T12 is turned on, DT provides a display data voltage Vdata, and the Vdata charges N1 through T0 and T13, so that the potential of N1 becomes VSS1+Vth, where Vth is a threshold voltage of TO.

In the light-emitting stage S4, the EM provides a high voltage signal, T11 is turned on, VDD2 is written into N2, and the potential of N1 becomes VSS1+Vth+VSS2−Vdata through self-booting effect of Cst; the gate-source voltage of T0 is VSS1+Vth−Vdata, and the drive current Id flowing through M1 is equal to K(VSS1−Vdata)², so as to be able to eliminate the influence of the IR voltage drop; where K is the current coefficient of T0.

When displaying a middle-to-high gray level, the gate electrode of the T10 is connected to the light-emitting control signal provided by the EM, the T10 is turned on, and the M1 emits light.

When displaying a low gray level, the gate electrode of the T10 is connected to the light-emitting control voltage provided by the HF; when HF provides a low voltage signal, T10 turns on and M1 emits light, achieving PWM display.

In the operation of at least one embodiment of the pixel circuit shown in FIG. 23 of the present disclosure,
in the reset stage S1, the potential of N1 is Vint, and the potential of N2 is Vref;
in the selection stage S2, the potential of N1 is Vint, and the potential of N2 is Vref;
in the data write and compensation stage S3, the potential of N1 is Vdata, and the potential of N2 is VSS1+Vth; Vth is the threshold voltage of TO; and in the light-emitting stage S4, the potential of N1 is VDD2, and the potential of N2 is VSS1+Vth+VSS2−Vdata.

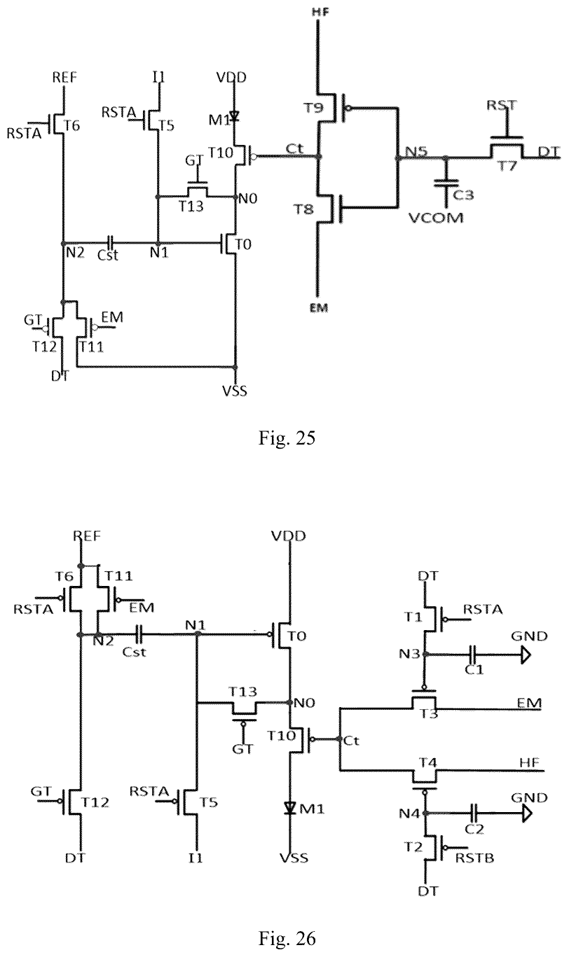

As shown in FIG. 25, on the basis of at least one embodiment of the pixel circuit shown in FIG. 16, the light-emitting element is a micro light-emitting diode M1.

The third write circuit includes a seventh transistor T7, the third control circuit includes an eighth transistor T8, and the fourth control circuit includes a ninth transistor T9.

A gate electrode of the seventh transistor T7 is electrically connected to the initial control terminal RST, a source electrode of the seventh transistor T7 is electrically connected to the data line DT, and a drain electrode of the seventh transistor T7 is electrically connected to the fifth node N5.

A gate electrode of the eighth transistor T8 is electrically connected to the fifth node N5, a source electrode of the eighth transistor T8 is electrically connected to the light-emitting control terminal EM, and a drain electrode of the eighth transistor T8 is electrically connected to the control node Ct.

A gate electrode of the ninth transistor T9 is electrically connected to the fifth node N5, a source electrode of the ninth transistor T9 is electrically connected to the light-emitting control voltage terminal HF, and a drain electrode of the ninth transistor T9 is electrically connected to the control node Ct.

The third voltage sustaining circuit includes a third capacitor C3.

A first terminal of the third capacitor C3 is electrically connected to the fifth node N5, and a second terminal of the third capacitor C3 is electrically connected to a common electrode voltage terminal VCOM.

The first initialization circuit includes a fifth transistor T5, and the second initialization circuit includes a sixth transistor T6.

A gate electrode of the fifth transistor T5 is electrically connected to the initial control terminal RST, a source electrode of the fifth transistor T5 is electrically connected to the initial voltage terminal I1, and a drain electrode of the fifth transistor T5 is electrically connected to the first node N1; the initial voltage terminal I1 is configured to provide an initial voltage Vint.

A gate electrode of the sixth transistor T6 is electrically connected to the initial control terminal RST, a source electrode of the sixth transistor T6 is electrically connected to the reference voltage terminal REF, and a drain electrode of the sixth transistor T6 is electrically connected to the second node N2; and the reference voltage terminal REF is configured to provide a reference voltage Vref.

The drive circuit includes a drive transistor T0, the energy storage circuit includes a storage capacitor Cst, the light-emitting control circuit includes a tenth transistor T10, and the voltage control circuit includes an eleventh transistor T11.

A gate electrode of the drive transistor T0 is electrically connected to the first node N1, a source electrode of the drive transistor T0 is electrically connected to the drive node N0, and a drain electrode of the drive transistor T0 is electrically connected to the low voltage terminal VSS.

A first terminal of the storage capacitor Cst is electrically connected to a first node N1, and a second terminal of the storage capacitor Cst is electrically connected to a second node N2.

The anode of the micro light-emitting diode M1 is electrically connected to a power supply voltage terminal VDD.

A gate electrode of the tenth transistor T10 is electrically connected to the control node Ct, a source electrode of the tenth transistor T10 is electrically connected to a cathode of the micro light-emitting diode M1, and a drain electrode of the tenth transistor T10 is electrically connected to the drive node N0.

A gate electrode of the eleventh transistor T11 is electrically connected to the light-emitting control terminal EM, a source electrode of the eleventh transistor T11 is electrically connected to the low voltage terminal VSS, and a drain electrode of the eleventh transistor T11 is electrically connected to the second node N2.

The data write circuit includes a twelfth transistor T12, and the compensation control circuit includes a thirteenth transistor T13.

A gate electrode of the twelfth transistor T12 is electrically connected to the write control terminal GT1, a source electrode of the twelfth transistor T12 is electrically connected to the data line DT, and a drain electrode of the twelfth transistor T12 is electrically connected to the second node N2.

A gate electrode of the thirteenth transistor T13 is electrically connected to the compensation control terminal GT2, a source electrode of the thirteenth transistor T13 is electrically connected to the first node N1, and a drain electrode of the thirteenth transistor T13 is electrically connected to the drive node N0.

In at least one embodiment of the pixel circuit shown in FIG. 25, the second voltage terminal is a low voltage terminal VSS.

In at least one embodiment of the pixel circuit shown in FIG. 25 of the present disclosure, T0, T5, T6, T7, T8, and T13 are n-type transistors, and T9, T10, T11, and T12 are all p-type transistors.

At least one embodiment of the pixel circuit shown in FIG. 26 of the present disclosure differs from at least one embodiment of the pixel circuit shown in FIG. 17 of the present disclosure in that: the source electrode of T11 is electrically connected to the reference voltage terminal REF, and the reference voltage terminal is configured to provide a reference voltage Vref.

FIG. 18 is a timing diagram of operation of at least one embodiment of the pixel circuit shown in FIG. 26 of the present disclosure.

In the operation of at least one embodiment of the pixel circuit shown in FIG. 26 of the present disclosure, in a light-emitting stage, the gate-source voltage of T0 is Vref+Vth−Vdata, and the drive current Id flowing through M1 is equal to K(Vref− Vdata)², so as to be able to eliminate the influence of the IR voltage drop; where K is the current coefficient of T0.

In at least one embodiment of the pixel circuit shown in FIG. 26, the second voltage terminal is the reference voltage terminal REF.

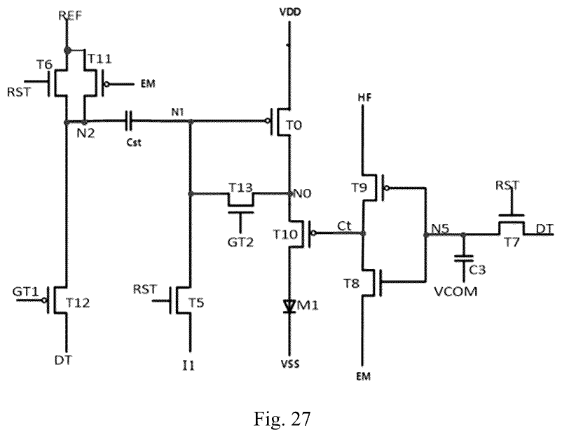

At least one embodiment of the pixel circuit shown in FIG. 27 of the present disclosure differs from at least one embodiment of the pixel circuit shown in FIG. 19 of the present disclosure in that: the source electrode of T11 is electrically connected to the reference voltage terminal REF, and the reference voltage terminal is configured to provide a reference voltage Vref.

FIG. 20 is a timing diagram of operation of at least one embodiment of the pixel circuit shown in FIG. 27 of the present disclosure.

In the operation of at least one embodiment of the pixel circuit shown in FIG. 27 of the present disclosure, in a light-emitting stage, the gate-source voltage of T0 is Vref+Vth−Vdata, and the drive current Id flowing through M1 is equal to K(Vref−Vdata)², so as to be able to eliminate the influence of the IR voltage drop; where K is the current coefficient of T0.

In at least one embodiment of the pixel circuit shown in FIG. 27, the second voltage terminal is the reference voltage terminal REF.

A display device according to embodiments of the present disclosure includes the above-described pixel circuit.

The above descriptions are preferred embodiments of the present disclosure. It should be noted that those skilled in the art that can make various improvements and modifications without departing from the principle of the present disclosure, and the improvements and the modifications shall fall within the scope of protection of the present disclosure.

What is claimed is:

1. A pixel circuit, comprising a light-emitting element, a drive circuit, a light-emitting control circuit, and a drive control circuit;
wherein the light-emitting control circuit is electrically connected to a control node, and is configured to control connection between the drive circuit and the light-emitting element or between the drive circuit and a power supply voltage terminal under control of a potential of the control node;
wherein the drive circuit is electrically connected to a first node, and the drive circuit is configured to generate a drive current flowing from the power supply voltage terminal to the light-emitting element under control of a potential of the first node; and
wherein the drive control circuit is electrically connected to the control node, a data line, an initial control terminal, a light-emitting control terminal, and a light-emitting control voltage terminal, and is configured to control connection between the control node and the light-emitting control terminal or the light-emitting control voltage terminal according to a voltage signal provided by the data line under control of an initial control signal provided by the initial control terminal.

2. The pixel circuit according to claim 1, wherein a control terminal of the drive circuit is electrically connected to the first node, a first terminal of the drive circuit is electrically connected to the power supply voltage terminal, and a second terminal of the drive circuit is electrically connected to a drive node, and the drive circuit is configured to generate a drive current flowing from the power supply voltage terminal to the drive node under control of the potential of the first node;
wherein the light-emitting control circuit is further electrically connected to the drive node and a first electrode of the light-emitting element, and is configured to control connection between the drive node and the first electrode of the light-emitting element under control of the potential of the control node; and a second electrode of the light-emitting element is electrically connected to a first voltage terminal.

3. The pixel circuit according to claim 1, wherein a control terminal of the drive circuit is electrically connected to the first node, a first terminal of the drive circuit is electrically connected to a drive node, a second terminal of the drive circuit is electrically connected to a first voltage terminal, and the drive circuit is configured to generate a drive current flowing from the drive node to the first voltage terminal under control of the potential of the first node;
wherein a first electrode of the light-emitting element is electrically connected to the power supply voltage terminal; and
wherein the light-emitting control circuit is further electrically connected to a second electrode of the light-emitting element and the drive node, and is configured to control connection between the second electrode of the light-emitting element and the drive node under control of the potential of the control node.

4. The pixel circuit according to claim 1, further comprising an energy storage circuit and a voltage control circuit;
wherein a first terminal of the energy storage circuit is electrically connected to the first node, a second terminal of the energy storage circuit is electrically connected to a second node, and the energy storage circuit is configured to store electric energy; and
wherein the voltage control circuit is electrically connected to the light-emitting control terminal, a second voltage terminal, and the second node, and is configured to control connection between the second voltage terminal and the second node under control of a light-emitting control signal provided by the light-emitting control terminal.

5. The pixel circuit according to claim 4, wherein the initial control terminal comprises a first initial control terminal and a second initial control terminal;
wherein the drive control circuit comprises a first write circuit, a second write circuit, a first control circuit, a second control circuit, a first voltage sustaining circuit, and a second voltage sustaining circuit;
wherein the first write circuit is electrically connected to a third node, the data line, and the first initial control terminal, and is configured to control connection between the data line and the third node under control of a first initial control signal provided by the first initial control terminal;
wherein the second write circuit is electrically connected to a fourth node, the data line, and the second initial control terminal, and is configured to control connection between the data line and the fourth node under control of a second initial control signal provided by the second initial control terminal;
wherein the first control circuit is electrically connected to the third node, the light-emitting control terminal, and the control node, and is configured to control connection between the light-emitting control terminal and the control node under control of a potential of the third node;
wherein the second control circuit is electrically connected to the fourth node, the light-emitting control voltage terminal, and the control node, and is configured to control connection between the light-emitting control voltage terminal and the control node under control of a potential of the fourth node;
wherein the first voltage sustaining circuit is electrically connected to the third node, and is configured to sustain the potential of the third node; and
wherein the second voltage sustaining circuit is electrically connected to the fourth node, and is configured to sustain the potential of the fourth node.

6. The pixel circuit according to claim 5, further comprising a first initialization circuit and a second initialization circuit;
wherein the first initialization circuit is electrically connected to the first initial control terminal, an initial voltage terminal, and the first node, and is configured to write an initial voltage provided by the initial voltage terminal into the first node under control of the first initial control signal provided by the first initial control terminal; and
wherein the second initialization circuit is electrically connected to the first initial control terminal, a reference voltage terminal, and the second node, and is configured to write a reference voltage provided by the reference voltage terminal into the second node under control of the first initial control signal provided by the first initial control terminal.

7. The pixel circuit according to claim 4, wherein the drive control circuit comprises a third write circuit, a third control circuit, a fourth control circuit, and a third voltage sustaining circuit;
wherein the third write circuit is electrically connected to a fifth node, the data line, and the initial control terminal, and is configured to control connection between the data line and the fifth node under control of the initial control signal provided by the initial control terminal;
wherein the third control circuit is electrically connected to the fifth node, the light-emitting control terminal, and the control node, and is configured to control connection between the control node and the light-emitting control terminal under control of a potential of the fifth node;
wherein the fourth control circuit is electrically connected to the fifth node, the light-emitting control voltage terminal, and the control node, and is configured to control connection between the control node and the light-emitting control voltage terminal under control of the potential of the fifth node; and
wherein the third voltage sustaining circuit is electrically connected to the fifth node, and is configured to sustain the potential of the fifth node.

8. The pixel circuit according to claim 7, further comprising a first initialization circuit and a second initialization circuit;
wherein the first initialization circuit is electrically connected to the initial control terminal, an initial voltage terminal, and the first node, and is configured to write an initial voltage provided by the initial voltage terminal into the first node under control of the initial control signal provided by the initial control terminal; and
wherein the second initialization circuit is electrically connected to the initial control terminal, a reference voltage terminal, and the second node, and is configured to write a reference voltage provided by the reference voltage terminal into the second node under control of the initial control signal provided by the initial control terminal.

9. The pixel circuit according to claim 4, further comprising a data write circuit and a compensation control circuit;
wherein the data write circuit is electrically connected to a write control terminal, the data line, and the second node, and is configured to control connection between the data line and the second node under control of a write control signal provided by the write control terminal; and
wherein the compensation control circuit is electrically connected to a compensation control terminal, the first node, and a drive node, and is configured to control connection between the first node and the drive node under control of a compensation control signal provided by the compensation control terminal.

10. The pixel circuit according to claim 5, wherein the first write circuit comprises a first transistor, the second write circuit comprises a second transistor, the first control circuit comprises a third transistor, and the second control circuit comprises a fourth transistor;
wherein a gate electrode of the first transistor is electrically connected to the first initial control terminal, a first electrode of the first transistor is electrically connected to the data line, and a second electrode of the first transistor is electrically connected to the third node;
wherein a gate electrode of the second transistor is electrically connected to the second initial control terminal, a first electrode of the second transistor is electrically connected to the data line, and a second electrode of the second transistor is electrically connected to the fourth node;
wherein a gate electrode of the third transistor is electrically connected to the third node, a first electrode of the third transistor is electrically connected to the light-emitting control terminal, and a second electrode of the third transistor is electrically connected to the control node; and
wherein a gate electrode of the fourth transistor is electrically connected to the fourth node, a first electrode of the fourth transistor is electrically connected to the light-emitting control voltage terminal, and a second electrode of the fourth transistor is electrically connected to the control node.

11. The pixel circuit according to claim 5, wherein the first voltage sustaining circuit comprises a first capacitor, and the second voltage sustaining circuit comprises a second capacitor;
wherein a first terminal of the first capacitor is electrically connected to the third node, and a second terminal of the first capacitor is electrically connected to a direct current voltage terminal; and
wherein a first terminal of the second capacitor is electrically connected to the fourth node, and a second terminal of the second capacitor is electrically connected to the direct current voltage terminal.

12. The pixel circuit according to claim 6, wherein the first initialization circuit comprises a fifth transistor, and the second initialization circuit comprises a sixth transistor;
wherein a gate electrode of the fifth transistor is electrically connected to the first initial control terminal, a first electrode of the fifth transistor is electrically connected to the initial voltage terminal, and a second electrode of the fifth transistor is electrically connected to the first node; and
wherein a gate electrode of the sixth transistor is electrically connected to the first initial control terminal, a first electrode of the sixth transistor is electrically connected to the reference voltage terminal, and a second electrode of the sixth transistor is electrically connected to the second node.

13. The pixel circuit according to claim 7, wherein the third write circuit comprises a seventh transistor, the third control circuit comprises an eighth transistor, and the fourth control circuit comprises a ninth transistor;
wherein a gate electrode of the seventh transistor is electrically connected to the initial control terminal, a first electrode of the seventh transistor is electrically connected to the data line, and a second electrode of the seventh transistor is electrically connected to the fifth node;
wherein a gate electrode of the eighth transistor is electrically connected to the fifth node, a first electrode of the eighth transistor is electrically connected to the light-emitting control terminal, and a second electrode of the eighth transistor is electrically connected to the control node; and
wherein a gate electrode of the ninth transistor is electrically connected to the fifth node, a first electrode of the ninth transistor is electrically connected to the light-emitting control voltage terminal, and a second electrode of the ninth transistor is electrically connected to the control node.

14. The pixel circuit according to claim 7, wherein the third voltage sustaining circuit comprises a third capacitor; and
wherein a first terminal of the third capacitor is electrically connected to the fifth node, and a second terminal of the third capacitor is electrically connected to a direct current voltage terminal.

15. The pixel circuit according to claim 8, wherein the first initialization circuit comprises a fifth transistor, and the second initialization circuit comprises a sixth transistor;
wherein a gate electrode of the fifth transistor is electrically connected to the initial control terminal, a first electrode of the fifth transistor is electrically connected to the initial voltage terminal, and a second electrode of the fifth transistor is electrically connected to the first node; and
wherein a gate electrode of the sixth transistor is electrically connected to the initial control terminal, a first electrode of the sixth transistor is electrically connected to the reference voltage terminal, and the second electrode of the sixth transistor is electrically connected to the second node.

16. The pixel circuit according to claim 2, wherein the drive circuit comprises a drive transistor, and the light-emitting control circuit comprises a tenth transistor;
wherein a gate electrode of the drive transistor is electrically connected to the first node, a first electrode of the drive transistor is electrically connected to the power supply voltage terminal, and a second electrode of the drive transistor is electrically connected to the drive node; and
wherein a gate electrode of the tenth transistor is electrically connected to the light-emitting control terminal, a first electrode of the tenth transistor is electrically connected to the power supply voltage terminal, and a second electrode of the tenth transistor is electrically connected to the first electrode of the light-emitting element.

17. The pixel circuit according to claim 3, wherein the drive circuit comprises a drive transistor, and the light-emitting control circuit comprises a tenth transistor;
wherein a gate electrode of the drive transistor is electrically connected to the first node, a first electrode of the drive transistor is electrically connected to the drive node, and a second electrode of the drive transistor is electrically connected to the first voltage terminal; and
wherein a gate electrode of the tenth transistor is electrically connected to the light-emitting control terminal, a first electrode of the tenth transistor is electrically connected to the second electrode of the light-emitting element, and a second electrode of the tenth transistor is electrically connected to the drive node.

18. The pixel circuit according to claim 4, wherein the energy storage circuit comprises a storage capacitor, and the voltage control circuit comprises an eleventh transistor;
wherein a first terminal of the storage capacitor is electrically connected to the first node, and a second terminal of the storage capacitor is electrically connected to the second node; and
wherein a gate electrode of the eleventh transistor is electrically connected to the light-emitting control terminal, a first electrode of the eleventh transistor is electrically connected to the second voltage terminal, and a second electrode of the eleventh transistor is electrically connected to the second node.

19. The pixel circuit according to claim 9, wherein the data write circuit comprises a twelfth transistor, and the compensation control circuit comprises a thirteenth transistor;
wherein a gate electrode of the twelfth transistor is electrically connected to the write control terminal, a first electrode of the twelfth transistor is electrically connected to the data line, and a second electrode of the twelfth transistor is electrically connected to the second node; and
wherein a gate electrode of the thirteenth transistor is electrically connected to the compensation control terminal, a first electrode of the thirteenth transistor is electrically connected to the first node, and a second electrode of the thirteenth transistor is electrically connected to the drive node.

20. A display device, comprising the pixel circuit according to claim 1.
